(19) United States
(12) Patent Application Publication
(10) Pub. No.: US 2026/0287379 A1
(43) Pub. Date: Sep. 24, 2026

(54) SYSTEM

(71) Applicant: SoftBank Group Corp., Tokyo (JP)

(72) Inventor: Koshi KOZUKA, Tokyo (JP)

(73) Assignee: SoftBank Group Corp., Tokyo (JP)

(21) Appl. No.: 19/561,626

(22) Filed: Mar. 10, 2026

(30) Foreign Application Priority Data
Mar. 19, 2025 (JP) 2025-044944

(51) Int. Cl. G01C 21/36

(52) U.S. Cl. CPC G01C 21/3617; G01C 21/3676

(57) ABSTRACT

A system includes a processor that is configured to provide a user interface for setting a departure point and a destination, generate a prompt that instructs reference to a map database and execution of a route search algorithm to calculate an optimal travel route based on the departure point and the destination set by a user, and generate a prompt that instructs reference to a traffic information database and execution of a proposal algorithm to propose means of transportation and travel time based on the calculated travel route.

### CROSS-REFERENCE TO RELATED APPLICATION

This application is based on and claims priority under 35 USC 119 from Japanese Patent Application No. 2025-044944 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel planning systems typically require a user to manually search for routes, transportation options, and travel times by interacting with multiple independent services such as map services, traffic information services, and travel advisory sites. In such systems, the user must repeatedly enter departure points and destinations, interpret route search results, compare transportation means, and adjust travel plans by themselves.

Furthermore, when external information providing services or generative AI models are used, the user is often required to manually craft complex queries or prompts and then manually interpret the returned results. This imposes a significant cognitive load on the user and results in inefficient and time-consuming travel planning. In addition, known systems do not adequately support automatic optimization of transportation means and travel times based on up-to-date external information, nor do they seamlessly integrate generative AI models for generating tailored travel plans from user inputs. Therefore, there is a need for a system that can centrally orchestrate map databases, traffic information databases, external information services, and generative AI models, by generating appropriate prompts and instructions, so that a user can easily obtain optimized routes, transportation proposals, and personalized travel plans without complex manual operations.

### SUMMARY

To solve the above-described problems, according to one aspect of the invention, there is provided a system comprising a processor, wherein the processor is configured to provide a user interface for setting a departure point and a destination, generate a prompt that instructs reference to a map database and execution of a route search algorithm to calculate an optimal travel route based on the departure point and the destination set by a user, and generate a prompt that instructs reference to a traffic information database and execution of a proposal algorithm to propose means of transportation and travel time based on the calculated travel route. By automatically generating such prompts, the processor enables integrated and automated use of map and traffic information resources without requiring the user to directly operate underlying services.

In one preferred embodiment, the processor is further configured to generate a prompt that instructs optimization of the proposed means of transportation and travel time by using an external information providing service. In this manner, the system can obtain up-to-date information such as real-time traffic conditions, fare information, service availability, and delay information from external services, and can automatically refine or update the transportation proposals and travel times in response to such external information, thereby improving the accuracy and practicality of the suggested travel plan.

In another preferred embodiment, the processor is configured to generate a prompt that instructs, by using a generative AI model, inputting user input data as a prompt into the generative AI model based on input from the user, analyzing an output obtained from the generative AI model, and generating a travel plan. By doing so, the system can leverage the generative AI model to interpret free-form user preferences and constraints, such as desired activities, budget, and time constraints, and can automatically synthesize a comprehensive travel plan. The processor thus bridges between the user interface, structured databases, external information services, and the generative AI model by generating and managing prompts, so that the user can receive an optimized route, transportation proposals, and a personalized travel plan with reduced manual effort and improved usability.

The term “processor” refers to any hardware component or combination of hardware components, such as a central processing unit (CPU), a microprocessor, a microcontroller, a digital signal processor, or a set of such elements, that executes instructions to perform the described functions of the system.

The term “user interface” refers to any hardware and software combination that enables a user to input information to the system and to receive information from the system, including but not limited to graphical user interfaces (GUIs), web interfaces, mobile application interfaces, command-line interfaces, touchscreens, and voice-based interfaces.

The term “departure point” refers to a geographic location, such as a city, address, facility, or landmark, that is designated by a user as the starting location of a travel route.

The term “destination” refers to a geographic location, such as a city, address, facility, or landmark, that is designated by a user as the end location of a travel route.

The term “map database” refers to any data storage system or data structure that stores geographic information, including but not limited to road networks, points of interest, geographic coordinates, and related attributes, which can be used by a route search algorithm to calculate travel routes.

The term “route search algorithm” refers to any algorithm or computational procedure that determines a travel route between a departure point and a destination based on map data, including but not limited to shortest path algorithms, fastest route algorithms, or multi-criteria optimization algorithms.

The term “optimal travel route” refers to a travel route calculated by the route search algorithm that satisfies one or more optimization criteria, such as minimum travel time, minimum distance, minimum cost, or a weighted combination of such criteria, as defined by the system or by user preferences.

The term “prompt” refers to data, including but not limited to a command, an instruction, a query, or a structured message, that is generated by the processor for causing another component, service, or model to perform a predetermined operation, such as accessing a database, executing an algorithm, or generating an output.

The term “traffic information database” refers to any data storage system or data structure that stores information related to transportation and traffic, including but not limited to timetables, congestion information, delays, service availability, fares, and transportation modes.

The term “proposal algorithm” refers to any algorithm or computational procedure that proposes means of transportation and travel times based on a calculated travel route and traffic information, and optionally based on user preferences or constraints.

The term “means of transportation” refers to any type of transport mode or combination of transport modes that can be used to move a user from the departure point to the destination, including but not limited to trains, buses, airplanes, taxis, private cars, ride-sharing services, bicycles, and walking.

The term “travel time” refers to a duration or time period required or estimated for moving from one location to another, and may include in-vehicle time, transfer time, waiting time, or a combination thereof.

The term “external information providing service” refers to any external system, server, API, or online service, operated independently of the system, that supplies information usable for optimizing transportation means and travel times, such as real-time traffic services, fare information services, travel advisory services, or weather information services.

The term “generative AI model” refers to any machine learning model or artificial intelligence model that generates content, such as text, plans, or recommendations, in response to input data or prompts, including but not limited to large language models, transformer-based models, or other generative neural network architectures.

The term “user input data” refers to any data provided by a user through the user interface, including but not limited to departure points, destinations, travel dates, times, preferences, constraints, budget indications, and free-form text descriptions related to desired travel.

The term “travel plan” refers to structured information representing a proposed sequence of travel-related actions or events for a user, including but not limited to routes, transportation means, departure and arrival times, intermediate stops, and recommended activities or points of interest.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

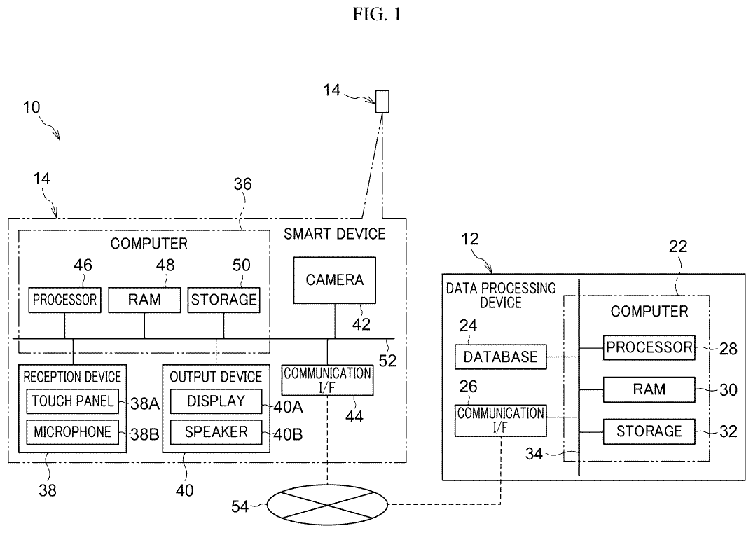

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

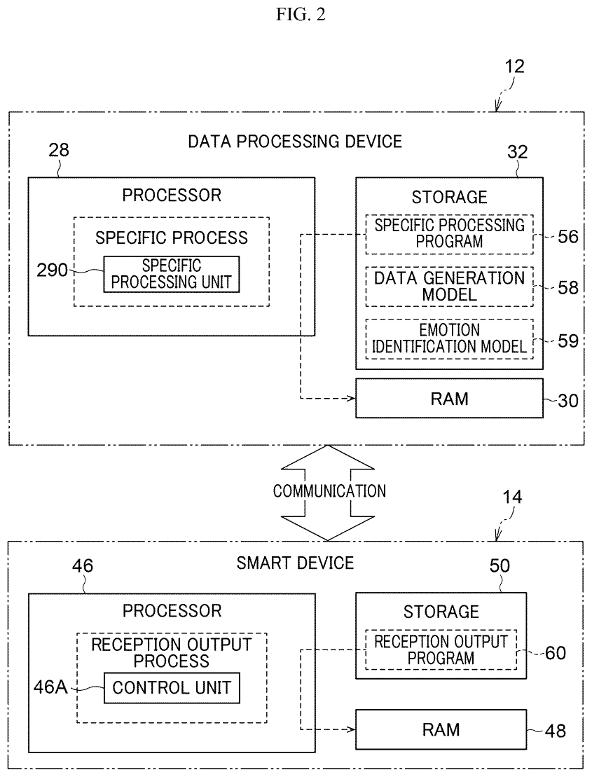

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented travel planning systems typically compute a route between a departure location and a destination location by invoking a routing engine on map data and then presenting a static list of segments and times to a user. These systems generally separate low-level route computation from high-level itinerary generation and do not tightly integrate external routing services with generative artificial intelligence models in a way that is aware of concrete route data. As a result, such systems suffer from several technical shortcomings.

First, the processor in conventional systems often performs redundant or fragmented processing across multiple components: one module calls an external routing service, another module formats results for display, and yet another, separate module may interface with a natural language system. The data exchanged among these modules is frequently unstructured or loosely coupled, which leads to inefficient use of memory resources, repeated parsing of route information, and increased latency when updating or refining travel plans. This fragmented architecture degrades the overall performance and scalability of the computer system, particularly when handling large numbers of concurrent route requests or complex itineraries with multiple constraints.

Second, existing systems usually treat user preferences or constraints-such as restrictions on transportation modes, limits on transfers, or preferences on travel time and cost—as simple filter conditions applied after a route has already been computed. Such post-processing often relies on ad hoc logic instead of a unified, machine-readable specification of optimization conditions. This causes increased computational load due to repeated route searches, as well as suboptimal use of external routing services that are capable of honoring constraints directly. The lack of a structured optimization framework in the processor leads to unnecessary network calls, additional processing overhead, and inconsistent results across different user sessions.

Third, where natural language systems are employed, conventional approaches often apply a generative artificial intelligence model in isolation from the underlying route computation. The generative model is typically prompted with free-form user text and general travel knowledge, without being provided with precise, machine-generated route data such as segment-wise distances, times, or classified transportation modes. This disconnect allows the model to generate itineraries that are inconsistent with actual route constraints, or that require subsequent manual correction. The processor must then perform additional checks or reconcile differences between narrative text and actual route data, which results in duplicated computations, memory copies, and increased processing latency.

Fourth, user interaction flows in known systems tend to be static and linear, providing only a limited feedback loop between the user interface and the underlying computational components. When a user refines conditions or enters additional natural language requests, the system frequently restarts the route computation from scratch, rather than reusing structured route data and contextual constraints. This behavior leads to inefficient consumption of processing cycles, larger volumes of network traffic, and poor responsiveness on resource-constrained client devices.

Accordingly, there is a need for an improved computer-implemented travel planning system in which a processor orchestrates, in an integrated and structured manner, (i) reception and structuring of location information from a terminal device, (ii) generation and transmission of optimized route calculation requests to an external route information providing apparatus, (iii) analysis and classification of returned route information into machine-readable movement sections, and (iv) generation of proposal information and detailed travel plan data using a generative artificial intelligence model that is explicitly conditioned on the structured route data and user-specified constraints. By addressing the inefficiencies in data structuring, constraint handling, external service utilization, and generative model integration, such a system can improve the operation of the computer itself, achieving reduced processing redundancy, lower end-to-end latency, and more accurate, constraint-consistent itineraries, thereby enhancing the overall performance and technical reliability of travel planning functions executed by the processor.

The specific processing by the specific processing unit 290 of the data processing device 12 in Example 1 is realized by the following means.

The present invention provides a server comprising a processor configured to provide, to a terminal device, an information input/output screen for receiving location information as a movement start position and a movement end position from a user; to receive, via a communication network, the location information transmitted from the terminal device, to generate structured data including the location information, and to transmit route calculation request data including the structured data to an external route information providing apparatus by using a secure communication scheme; to acquire route information relating to a plurality of candidate routes between the movement start position and the movement end position from the external route information providing apparatus, to analyze the route information, to calculate, for each candidate route, a movement time, a movement distance, and a transportation mode to be used, and to identify an optimal movement route from among the candidate routes based on a predetermined selection condition; to classify each movement section included in the identified optimal movement route into at least one of a walking section, a public transportation section, and a vehicle section, and to generate proposal information for each movement section, the proposal information including a departure time, an arrival time, a movement time, a movement distance, and the transportation mode to be used; to transmit the proposal information to the terminal device and to cause the terminal device to present, on the information input/output screen, the proposal information in a list format arranged in chronological order and as a route display on a map image; to cause the terminal device to present an input field for receiving, from the user, a prompt sentence described in natural language as a generation request for a detailed travel plan based on the proposal information, and to acquire the prompt sentence transmitted from the terminal device; to construct input data for a generative artificial intelligence model, the input data including the prompt sentence and the route information relating to the identified optimal movement route, to transmit the input data to the generative artificial intelligence model to cause the generative artificial intelligence model to generate travel plan text expressed in natural language, and to analyze the generated travel plan text to generate travel plan data including an itinerary overview, a section-by-section itinerary, and recommendations; and to transmit the travel plan data to the terminal device and to cause the terminal device to display, on the information input/output screen, the travel plan text in association with the proposal information. This enables an integrated computer-implemented travel planning operation in which structured route computation, constraint-aware optimization, and generative itinerary generation are orchestrated by the processor in a unified data flow, thereby reducing redundant processing, improving utilization of external routing services, enforcing consistency between narrative itineraries and underlying route data, and enhancing responsiveness and scalability of the travel planning functions executed by the server.

The term “system” refers to a combination of one or more computing devices, including at least a server-side computing device and one or more terminal devices, that cooperate via a communication network to execute the functions described herein.

The term “server” refers to a computing device or a group of computing devices that includes at least one processor and memory, is connected to a communication network, and executes server-side programs to perform central processing, data management, and communication control in the system.

The term “processor” refers to one or more hardware processing units, such as a central processing unit or a processing core, and may include associated control circuitry configured to execute instructions stored in memory to perform the operations described herein.

The term “terminal device” refers to a user-operated computing device, such as a mobile device, a tablet, a laptop, or a desktop device, that includes an input/output interface, a display, and a communication interface for interacting with the server.

The term “communication network” refers to any wired or wireless network infrastructure, such as a local area network, a wide area network, or a public network, that enables data transfer between the server, the terminal device, and external apparatuses.

The term “information input/output screen” refers to a graphical user interface displayed on a display unit of the terminal device, through which a user can input information and view information output from the server.

The term “location information” refers to information identifying a geographic position, such as a place name, an address, or coordinate data, that can be used by a computer system to determine a physical location.

The term “movement start position” refers to location information representing a geographic position from which a user intends to begin a trip or movement.

The term “movement end position” refers to location information representing a geographic position at which a user intends to end a trip or movement.

The term “structured data” refers to data that is organized according to a predetermined format, such as key-value pairs, records, or hierarchical data structures, enabling the data to be systematically processed by a computer program.

The term “route calculation request data” refers to structured data transmitted from the server to an external apparatus, the data including at least location information for a movement start position and a movement end position and optionally one or more optimization conditions, and being formatted for processing by a route computation service.

The term “secure communication scheme” refers to a communication protocol or mechanism that provides at least data confidentiality and data integrity, such as an encrypted transport protocol that protects data exchanged between the server and another apparatus.

The term “external route information providing apparatus” refers to a computing system or service, separate from the server, that receives route calculation request data and returns route information including candidate routes, travel times, and related parameters.

The term “route information” refers to data describing one or more routes between two or more locations, including at least identifiers of the locations along the routes and associated movement parameters such as distance and time.

The term “candidate route” refers to one of a plurality of possible routes computed between a movement start position and a movement end position, which may differ in movement time, movement distance, or transportation mode.

The term “optimal movement route” refers to a candidate route selected from among a plurality of candidate routes based on at least one predetermined selection condition, such as minimal travel time, minimal distance, or minimal number of transfers.

The term “predetermined selection condition” refers to at least one rule or criterion defined in advance, used by the processor to select an optimal movement route from among candidate routes.

The term “movement section” refers to a segment of a route between two sequential points, during which a user moves using a single transportation mode or continues walking without changing the mode of movement.

The term “walking section” refers to a movement section in which the user moves primarily on foot over a route segment.

The term “public transportation section” refers to a movement section in which the user moves using a public transportation mode, such as a train, a subway, or a bus, over a route segment.

The term “vehicle section” refers to a movement section in which the user moves using a vehicle other than public transportation, such as a private car, a taxi, or a hired vehicle.

The term “movement time” refers to a length of time required to travel along a movement section or along an entire route, typically represented as a duration between a departure time and an arrival time.

The term “movement distance” refers to a length of distance along a movement section or along an entire route, represented in a measurable unit such as meters or kilometers.

The term “transportation mode” refers to a category of means of transport used in a movement section, such as walking, train, bus, or car.

The term “proposal information” refers to structured data generated by the processor for each movement section or for an entire route, the data including at least a departure time, an arrival time, a movement time, a movement distance, and a transportation mode to be used.

The term “map image” refers to a graphical representation of geographic information, displayed on a display unit, on which routes and positions are visually presented.

The term “prompt sentence” refers to a sequence of characters forming a natural language input expression, entered by a user, that instructs or requests a generative artificial intelligence model to generate a particular output.

The term “generative artificial intelligence model” refers to a trained machine learning model that receives input data, including at least a prompt sentence, and generates natural language text or equivalent content based on learned patterns.

The term “input data for a generative artificial intelligence model” refers to data produced by the processor, including at least a prompt sentence and route information, that is formatted as an input for the generative artificial intelligence model.

The term “travel plan text” refers to natural language text generated by a generative artificial intelligence model, describing at least a travel itinerary, movement steps, or recommendations related to a route.

The term “travel plan data” refers to structured data derived from travel plan text, including at least an itinerary overview, section-by-section itinerary information, and recommendations, suitable for programmatic handling and display.

The term “itinerary overview” refers to summary information describing a travel plan as a whole, including at least main transportation modes, major waypoints, and an overall timeline.

The term “section-by-section itinerary” refers to detailed information for each movement section in a travel plan, including at least an order of sections, times, distances, and transportation modes.

The term “recommendations” refers to additional guidance, suggestions, or advisories related to a travel plan, including, for example, advice on transfer points, rest breaks, or points of interest.

The term “optimization condition” refers to a constraint or preference specified for route computation, including at least one of a type of transportation mode, a number of transfers, a movement time constraint, or a movement distance constraint.

The term “type of transportation mode” refers to a classification attribute indicating permissible or preferred categories of transportation modes, such as “only public transportation” or “exclude walking beyond a certain distance.”

The term “number of transfers” refers to a numerical value representing how many times a user changes from one transportation mode or service to another along a route.

The term “desired condition relating to movement time” refers to a preference or constraint specified by a user regarding travel duration, such as maximum allowed travel time or preferred departure or arrival times.

The term “desired condition relating to cost” refers to a preference or constraint specified by a user regarding monetary expense for a trip, such as a maximum budget or a priority for lower-cost options.

The term “desired condition relating to a point of interest” refers to a preference or constraint that specifies inclusion, exclusion, or prioritization of particular locations or types of locations, such as tourist attractions or facilities, within a travel plan.

The term “use restriction on a specific transportation mode” refers to a limitation indicating that a particular transportation mode shall not be used or shall be limited in use in a computed route or in a generated travel plan.

In one embodiment, a server cooperates with one or more terminal devices operated by a user to provide optimized route proposals and detailed travel plans generated by a generative AI model. The server includes at least one processor, a main memory, a non-volatile storage device, and a network interface. The terminal includes at least one processor, a display, an input device such as a touch panel or keyboard, and a wireless or wired communication interface.

The terminal executes an application program, such as a native mobile application or a browser-based web application, that renders an information input/output screen. The terminal presents to the user input fields for a movement start position and a movement end position, and an additional input field for a natural-language prompt sentence when a detailed AI-based plan is requested. The terminal may run on a smartphone, a tablet, or a personal computer, and may use a graphical user interface toolkit such as a mobile operating system user interface framework or a browser rendering engine to display text fields, buttons, and map images.

The server executes one or more backend software components, such as a web application framework, a routing integration module, a data structuring module, a generative AI integration module, and a response formatting module. The server stores structured representations of route requests and route responses in memory using explicit data structures, for example records that include fields for origin, destination, optimization conditions, route identifiers, and lists of movement sections.

The server uses an external route information providing apparatus as a routing backend. The server accesses, via a secure protocol such as an encrypted transport protocol, an external routing service that maintains a large-scale map database and executes routing algorithms.

The external routing service returns route information in a structured response format such as a hierarchical object with arrays of candidate routes, legs, and steps. The server parses this response and converts it into internal route data structures that can be efficiently reused by subsequent components, including the generative AI integration module.

The server classifies each movement section in the internal route data according to a transportation mode category, such as walking, public transportation, or vehicle. The server calculates, for each movement section, a movement time and movement distance by aggregating or converting raw duration and distance values from the external routing service response. The server also associates, with each movement section, at least one departure time, arrival time, and line or service identifier if available. The server stores these values in memory using compact numerical representations and indexed collections to enable fast lookups during later processing.

The server generates proposal information by grouping movement sections in order and forming, for each section, a record that contains a section type, a description string, a movement time, a movement distance, and a transportation mode label. The server also generates summary information that includes a total movement time, a total movement distance, a primary transportation mode, and the number of transfers. The server then converts these internal representations to a format suitable for the terminal, such as a serialized structure where each field is explicitly named and can be rendered as a list and as a polyline on a map image.

The terminal receives the proposal information, decodes it, and generates visual elements on the display. The terminal draws a list of segments in chronological order and overlays a route polyline on a map view provided by a map rendering library. The terminal links each list element to a segment of the polyline so that user actions, such as tapping on a list item, can cause the terminal to highlight the corresponding segment on the map. By organizing the data into consistent segment objects and using identifiers to link them to graphical elements, the terminal reduces the amount of redundant redraw operations and improves rendering efficiency.

The user examines the displayed proposal information and may request a more detailed travel plan using a prompt sentence. The user enters the prompt sentence in natural language into the input field shown on the terminal. Examples of such prompt sentences include:

“Please create a detailed travel plan from the movement start position to the movement end position, including recommended departure time, transfer guidance, and rest suggestions.” “Revise the plan to avoid buses and use only trains and walking.”

“Generate a one-day sightseeing plan between the movement start position and the movement end position using only public transportation, with approximate times for each move and visit.”

“Shorten the total travel time even if the cost increases, and recommend at least two points of interest along the way.”

The terminal sends the prompt sentence, together with an identifier of the current optimal route and the associated route data, to the server. The server then constructs structured input data for a generative AI model. In one embodiment, the server uses a transformer-based neural network as the generative AI model. The generative AI model is a sequence-to-sequence architecture having multiple encoder and decoder layers, each layer including multi-head self-attention mechanisms, feed-forward sublayers, and layer normalization sublayers. The model parameters include weight matrices and bias vectors for attention projections and feed-forward layers.

The server converts route information, including movement sections, times, distances, and transportation modes, into a sequence of tokens that are concatenated or otherwise merged with tokens representing the prompt sentence. The server may apply a tokenizer that converts text and symbolic representations of numeric values into subword or wordpiece tokens. The model thus receives, in a single input sequence, both human-readable conditions and machine-generated route constraints.

The generative AI model processes the input sequence by repeatedly applying attention and feed-forward computations. In particular, the model uses attention mechanisms that compute, for each token, weighted sums of other token representations according to learned attention scores. This enables the model to correlate user constraints described in the prompt sentence, such as “avoid buses” or “shorten total travel time,” with specific sections and fields of the route data, such as section types classified as bus segments or sections having long movement times. The model then outputs a sequence of tokens representing a travel plan text that describes, for example, which segments should be modified or emphasized, how transfers should be handled, and what points of interest should be visited.

The generative AI model is trained in advance using a large corpus of travel-related texts and synthetic route data. During training, a cost function such as cross-entropy loss is used to measure the difference between the generated token distribution and the ground truth token sequence. The model weights are updated using gradient-based optimization, for instance by applying a stochastic gradient descent algorithm or a variant thereof such as Adam. Training data may include examples of prompt sentences combined with structured route annotations so that the model learns to associate explicit route constraints with natural language instructions.

The server receives the output token sequence of the generative AI model and decodes it into travel plan text. The server then parses the travel plan text to identify and segment sections of the plan, such as an itinerary overview, section-by-section details, and recommendations. The server may apply pattern-based extraction or additional lightweight natural language processing to detect headings, time expressions, and location names within the generated text.

The server creates travel plan data structures in memory that associate each piece of generated text with the underlying movement sections and route identifiers. This association allows the server and the terminal to present synchronized views where selection of a text portion highlights the related route segment on the map.

By integrating explicit route data into the model input and associating model output with structured route data, the server improves the correctness and consistency of itineraries. The model is constrained by the actual route sections, times, and distances, so that generated text is less likely to specify impossible transfers or non-existent connections. The server thereby reduces the need for post-generation correction and validation logic, which reduces processor cycles and memory access operations compared to conventional systems that attempt to reconcile free-form narrative text with route data after the fact.

The server further applies non-standard rule-based post-processing steps that operate on both the route data and the generated text. For example, when the prompt sentence specifies “avoid buses,” the server can enforce this constraint by scanning the internal movement sections for any public transportation section classified as bus and discarding or rewriting parts of the generated text that reference such sections. The server may also reweight candidate movement sections according to cost, distance, or user preferences, and selectively request the generative AI model to rephrase only localized parts of the itinerary. This hybrid rule-based and neural processing flow is not a mere automation of human work but a particular computational pipeline that reduces network calls and re-computation of full routes, thereby improving computing efficiency.

In one variation, the server caches intermediate structured route data and feature vectors derived from that data. Feature vectors may include normalized movement times, distances, counts of particular transportation mode transitions, and binary flags indicating whether certain constraints are satisfied. The server uses these feature vectors as additional input channels to the generative AI model or to an auxiliary classifier that predicts whether a given route aligns with user preferences. By maintaining and reusing these feature vectors, the server avoids recomputing summary statistics when the user issues multiple, iteratively refined prompt sentences for the same origin-destination pair, reducing total latency and server load.

In another variation, the server deploys multiple generative AI models specialized for different aspects of travel planning, such as one model for scheduling and another for recommendation of points of interest. The server selects or combines models based on content in the prompt sentence and the optimization conditions included in the route calculation request data. The server may, for example, first call a scheduling model to adjust times and transfers according to constraints, and then call a recommendation model to insert suggestions for rest breaks or visits to points of interest along the identified route. The server merges outputs of these models into a unified travel plan text while preserving the association to the underlying movement sections.

The use of structured data for both route computation and AI integration, along with explicit classification of movement sections, yields technical effects in the operation of the computer system. Memory access patterns are improved because the processor reads and writes compact section records instead of repeatedly parsing large, unstructured JSON documents. Network traffic is reduced because the server transmits compact identifiers and constraint summaries between modules rather than repeatedly sending full raw route descriptions. Processing time is lowered because the generative AI model receives combined inputs in a single call, avoiding the need for multiple cycles of generation and validation.

The terminal benefits from reduced payload sizes and more predictable rendering behavior. Because the server provides pre-classified and pre-linked segment information, the terminal can update only affected segments on the graphical interface when the user requests modifications via additional prompt sentences. This reduces redraw overhead on the terminal device, which is particularly beneficial in scenarios where the terminal has limited computing resources.

The system as implemented in this manner is not limited to travel planning for human users.

The same framework can be applied to routing of delivery vehicles, scheduling of maintenance operations, or multi-modal logistics tasks, where location information, optimization conditions, and generative explanation or instruction text are required. In every such embodiment, the server structures the route computation and AI-based text generation in a way that enhances computational efficiency and accuracy, and not merely automates a conceptual human planning process.

The user interacts with the system only through the terminal interface, and the internal processing, including structuring of data, execution of routing algorithms by the external apparatus, and execution of transformer-based generative AI models by the server or a specialized AI service, proceeds entirely within the computing infrastructure. By defining concrete data structures, model architectures, and control logic, the system achieves improved processing throughput, reduced error rates in itineraries, and more consistent application of user constraints than conventional, loosely coupled designs.

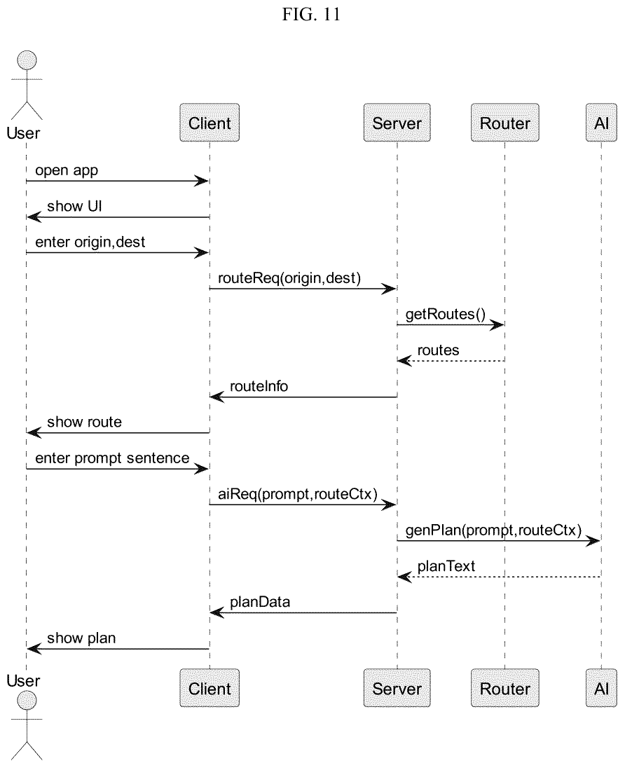

The following describes the processing flow using FIG. 11.

### Step 1:

The user operates the terminal and opens an application or web page that provides a travel planning interface.

Input: No structured data is yet provided; the user only sees an empty interface.

Operation: The terminal renders an information input/output screen including text input fields labeled as a movement start position and a movement end position, and interactive elements such as buttons for submitting a route request and for requesting an AI-based detailed plan.

The terminal uses its display hardware and a GUI framework to draw these elements.

Output: The terminal presents an interactive screen ready to receive location information and later a prompt sentence.

### Step 2:

The user enters a movement start position and a movement end position into the input fields on the terminal.

Input: The terminal receives user keystrokes or touch input corresponding to place names, addresses, or coordinates.

Operation: The terminal converts the user's key inputs into text strings encoded in a character format and stores them temporarily in memory as separate variables (for example, “origin_text” and “destination_text”). The terminal performs basic validation, such as checking that each field is not empty and that the text length does not exceed a preset limit. Output: The terminal holds validated text strings representing the movement start position and the movement end position.

### Step 3:

The terminal constructs and sends route calculation request data to the server.

Input: The terminal uses the stored text strings for the movement start position and the movement end position.

Operation: The terminal creates a structured message, for example a key-value object with keys corresponding to origin, destination, and optional optimization settings (such as preferred transportation modes). The terminal serializes this structured message, sets communication headers, and uses its network interface to send the message to the server via a secure communication protocol. The terminal then waits for a response.

Output: The server receives structured route calculation request data containing the location information.

### Step 4:

The server receives and parses the route calculation request data from the terminal.

Input: The server obtains a serialized message from the communication network containing at least the movement start position and the movement end position as text fields.

Operation: The server's network stack reads the incoming bytes and passes them to an application layer. The server deserializes the message into an internal data structure, extracting fields for the origin and destination. The server performs validation, such as checking required fields and normalizing whitespace or character encoding. The server then creates a structured route request object that includes the origin, destination, and any optimization conditions.

Output: The server stores a normalized route request object in memory that is ready to be used for external route computation.

### Step 5:

The server generates external route calculation request data and transmits it to an external route information providing apparatus.

Input: The server uses the internal route request object containing origin, destination, and possibly optimization conditions such as preferred transportation mode, maximum number of transfers, or limits on distance.

Operation: The server maps internal field names and values into a format required by the external routing service, for example query parameters or a structured message. The server may encode optimization conditions into parameters that instruct the external routing service to favor or avoid certain modes. The server then uses an HTTP client library to send a request over a secure protocol to the external apparatus.

Output: The external route information providing apparatus receives a normalized and constrained route calculation request.

### Step 6:

The server receives route information from the external route information providing apparatus and converts it into internal route data structures.

Input: The server obtains a route response message from the external apparatus, containing multiple candidate routes, each described by a hierarchy of legs and steps with distance, duration, and mode type.

Operation: The server deserializes the response and parses arrays of candidate routes. For each candidate route, the server iterates through legs and steps, reading numeric fields such as duration in seconds and distance in meters, and reading categorical fields such as mode of transportation. The server converts this information into internal route records, where each record represents a movement section with attributes including start location, end location, mode type, raw time, and raw distance.

Output: The server stores, in memory, a collection of internal route records grouped into candidate routes.

### Step 7:

The server analyzes candidate routes and identifies an optimal movement route.

Input: The server uses the internal collection of candidate routes, each consisting of multiple movement section records with times, distances, and modes.

Operation: The server computes, for each candidate route, aggregated values such as total movement time, total movement distance, number of transfers, and counts of each transportation mode. The server applies predetermined selection conditions, such as minimizing total travel time, minimizing transfers, or balancing cost against time if estimated cost information is available. The server compares the aggregate metrics among candidate routes and selects one or more routes that satisfy the conditions. This may involve sorting or scanning through all candidates and tracking the best candidate according to defined criteria.

Output: The server designates at least one candidate as an optimal movement route and stores a reference to its associated movement sections.

### Step 8:

The server classifies movement sections of the optimal movement route and generates proposal information.

Input: The server uses the movement section records of the selected optimal route, each containing raw mode type, duration, and distance.

Operation: The server applies classification rules to assign each section to one of several categories, such as walking, public transportation, or vehicle. The server converts raw duration values into user-friendly units such as minutes and hours, and converts raw distances into units such as kilometers. For each section, the server creates a proposal record that includes the section type, a readable description string, the movement time, the movement distance, and the transportation mode label. The server also aggregates section data to generate summary proposal information, such as total travel time, total travel distance, and main mode.

Output: The server holds structured proposal information, including a list of section-wise proposal records and summary data for the optimal movement route.

### Step 9:

The server transmits the proposal information to the terminal and the terminal prepares it for display.

Input: The server uses the structured proposal information for the selected route.

Operation (server side): The server serializes the proposal information into a response message that contains summary fields and an ordered list of movement sections. The server sends this message back to the terminal through a secure communication channel.

Operation (terminal side): The terminal receives the message, deserializes it, and constructs internal display objects corresponding to the summary and each movement section. The terminal may map each section to graphical elements in a list and to corresponding segments on a map view.

Output: The terminal has internal representations of the proposal information ready to be rendered to the user.

### Step 10:

The terminal displays the proposal information and allows the user to review it.

Input: The terminal uses the internal display objects for the summary and for each movement section.

Operation: The terminal renders a list of movement sections in chronological order, showing information such as “Walk 10 minutes,” “Take train 150 minutes,” along with departure and arrival points. The terminal also renders a map image or interactive map component, drawing a polyline for the route and markers for key locations. The terminal links list entries to map segments so that user interactions can highlight corresponding segments.

Output: The user sees a visual representation of the optimal movement route, including segment details and the overall route on a map.

### Step 11:

The user decides to request a more detailed travel plan and inputs a prompt sentence on the terminal.

Input: The user uses the keyboard or touch input to enter a natural-language prompt sentence describing additional conditions or requesting a more detailed itinerary.

Operation: The terminal displays a text input field labeled for AI-based planning. The user types a prompt sentence such as “Please create a detailed travel plan from the movement start position to the movement end position, including recommended departure time, transfer guidance, and rest suggestions,” or “Revise the plan to avoid buses and use only trains and walking.” The terminal converts the keystrokes into a text string and stores it in memory.

Output: The terminal holds a validated prompt sentence that expresses the user's requirements for AI-based planning.

### Step 12:

The terminal sends the prompt sentence and contextual route data to the server.

Input: The terminal uses the stored prompt sentence and identifiers or summaries of the currently displayed optimal route.

Operation: The terminal constructs a structured message that includes the prompt sentence as a text field and a reference to the route, such as a route identifier or embedded summary data (times, distances, and modes). The terminal serializes the message and sends it to the server using the existing secure communication channel.

Output: The server receives a message containing the prompt sentence and contextual route information.

### Step 13:

The server prepares input data for the generative AI model based on the prompt sentence and route information.

Input: The server uses the received prompt sentence and the internal route data associated with the referenced optimal movement route, including movement sections, times, distances, and classifications.

Operation: The server converts the prompt sentence into tokens using a tokenizer that splits text into units suitable for the generative AI model. The server also formats the route information into a structured textual or symbolic representation, for example by encoding each movement section as a string or symbol sequence containing section type, duration, distance, and mode. The server concatenates or otherwise merges the token sequence representing the prompt sentence with the token sequence representing route constraints, forming a combined input sequence.

Output: The server holds a combined input sequence or equivalent input structure ready to be submitted to the generative AI model.

### Step 14:

The server invokes the generative AI model and obtains travel plan text.

Input: The server provides the combined input sequence to the generative AI model, which is implemented as a trained neural network stored and executed on an AI-capable computing platform.

Operation: The generative AI model applies its learned parameters to the input sequence. The model processes the sequence through multiple layers of attention and feed-forward computation, internally generating vector representations for each token and attending across tokens to relate user-specified constraints in the prompt sentence to specific movement sections and constraints encoded from the route data. Based on these computations, the model predicts a sequence of output tokens representing a travel plan text. The server receives the output token sequence and decodes it into a human-readable string by mapping tokens back to characters.

Output: The server obtains a travel plan text in natural language that describes a detailed itinerary and recommendations consistent with the route data and the prompt sentence.

### Step 15:

The server post-processes the travel plan text and generates travel plan data structures.

Input: The server uses the decoded travel plan text and the underlying route data for the optimal movement route.

Operation: The server analyzes the travel plan text to detect structural elements such as an overall summary, section-by-section descriptions, and recommendations for transfers and points of interest. The server may apply simple parsing rules or pattern matching to identify headings and time-related expressions. The server creates travel plan data objects that associate each portion of the generated text with corresponding movement sections and route identifiers. The server may also insert or correct specific values such as actual movement times and distances derived from the route data to ensure consistency.

Output: The server holds structured travel plan data that combines narrative text with precise, section-linked route details.

### Step 16:

The server sends the travel plan data to the terminal, and the terminal prepares the detailed display.

Input: The server uses the structured travel plan data, including the travel plan text and its associations with movement sections.

Operation (server side): The server serializes the travel plan data into a response message and sends it to the terminal.

Operation (terminal side): The terminal receives the message, deserializes it, and constructs display objects for the itinerary overview, detailed section descriptions, and recommendations. The terminal links these text elements to the existing proposal information and map segments so that selection of a text portion can highlight the related route section.

Output: The terminal has all data necessary to render a detailed, AI-generated travel plan integrated with the route display.

### Step 17:

The terminal displays the AI-generated travel plan to the user and supports interactive refinement.

Input: The terminal uses the constructed display objects containing the travel plan text, section-by-section itinerary, and recommendations, along with existing proposal information and map data.

Operation: The terminal renders the travel plan text in a scrollable area, divided into sections such as overview, detailed steps, and tips. When the user selects a particular step in the text, the terminal highlights the corresponding movement section in the list and on the map. If the user is not satisfied and wants further adjustments, the user can enter additional prompt sentences, such as “Shorten the total travel time even if the cost increases,” and the terminal repeats the interaction with the server.

Output: The user views a synchronized, AI-generated travel plan and can further refine it through additional prompt sentences processed by the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional route planning systems for vehicles generally rely on fixed algorithmic pipelines implemented against static map databases and traffic information databases. In such systems, a processor typically executes a predetermined route-search algorithm over graph-structured map data and combines the result with tabular traffic data to compute a shortest or fastest path. This architecture has several technical limitations.

First, the processor is required to implement complex, hand-crafted logic to incorporate heterogeneous constraints such as user-specific preferences, desired categories of stop locations, flexible stay times, and arrival time windows. As these constraints increase, the control flow and data structures of the route-planning program become increasingly intricate, which leads to higher CPU usage, increased memory consumption, and reduced maintainability of the software. The processor must perform repeated recalculation of routes and schedules whenever the user changes conditions, resulting in duplicated computations and latency in generating updated plans.

Second, typical systems do not efficiently integrate unstructured or semi-structured content, such as descriptive information about regional specialties, sightseeing spots, and dining places, into the core routing computation. To handle such content, conventional implementations often attach ad hoc recommendation modules on top of the base routing logic. These modules are loosely coupled and require separate data retrieval, ranking, and filtering pipelines. As a result, the processor must coordinate multiple subsystems in a non-unified manner, which complicates data flow management and degrades the responsiveness and scalability of the route-planning service.

Third, existing systems lack a robust mechanism to leverage generative AI models in a way that is tightly integrated with low-level route computation components such as geocoding and external map routing services. In many naive integrations, a generative AI model is used only to output free-form text suggestions. The processor must then perform expensive post-processing, including natural language parsing and manual mapping of textual output to concrete geographic coordinates. This unstructured interaction between the generative AI model and the conventional route engine leads to ambiguity, frequent parsing failures, additional error-handling branches, and overall inefficiency in CPU cycles and network calls.

Fourth, when a user iteratively updates planning constraints, such as specifying new types of stop locations, modifying arrival time constraints, or changing total travel time limits, conventional systems typically re-execute the full route-search algorithm from scratch. This approach fails to reuse prior computation and does not exploit the generative capabilities of AI models to generate structured intermediate representations that are directly consumable by map routing services. Consequently, the system exhibits increased latency, greater server-side load, and a poor user experience, especially in real-time or high-traffic environments.

Accordingly, there is a need for an improved computer-implemented route planning architecture in which a processor can (i) systematically formulate prompt sentences for a generative AI model, (ii) obtain structured route-related information including intermediate locations and time parameters, (iii) translate this information into coordinate-based requests for external map information services, and (iv) generate and update detailed time plans in a unified pipeline. Such an architecture should reduce the complexity of custom algorithmic logic, improve data flow efficiency between components, and enable fast, consistent recalculation of route and schedule information when user conditions change, thereby improving the overall performance and technical operation of the route-planning computer system.

The specific processing by the specific processing unit 290 of the data processing device 12 in Application Example 1 is realized by the following means.

The present invention provides a server comprising a processor and a communication interface, the processor being configured to cause an information processing terminal, including a display device and an input device, to provide a user interface for setting a departure location and a destination location and to receive departure location data and destination location data from the information processing terminal via the communication interface; to generate, based on the departure location data and the destination location data, a control instruction sentence for route-search processing and to generate a prompt sentence for inputting the control instruction sentence into a generative AI model; to transmit, via the communication interface, the prompt sentence to the generative AI model operating on an external information processing apparatus and to receive, from the generative AI model, route-related information including intermediate location information arranged between the departure location data and the destination location data, movement time information between respective intermediate locations, and stay time information; to acquire position coordinate information for each location name included in the route-related information by referring to a location reference information database and to convert the departure location data, the destination location data, and the intermediate location information into corresponding position coordinate information; to transmit, via the communication interface, route calculation request data to an external map information providing apparatus, the route calculation request data instructing execution of route-calculation processing based on the position coordinate information, and to receive, from the external map information providing apparatus, detailed route information including movement distance information and movement required time information for each section; to calculate, based on the detailed route information and the stay time information received from the generative AI model, arrival time information and departure time information for each location in consideration of departure time information or arrival time constraint information, and to generate time plan information; and to generate route geometry information and location display information based on the position coordinate information and the detailed route information and to transmit the route geometry information, the location display information, and the time plan information to the information processing terminal via the communication interface so as to cause a map display device of the information processing terminal to perform route display and time plan display. This enables a computer-implemented route planning system in which the processor offloads high-level combinatorial planning to the generative AI model while maintaining structured, coordinate-based integration with external map and database services, thereby reducing custom algorithmic complexity, improving the efficiency of data transformations between textual prompts and geographic coordinates, and allowing rapid, consistent regeneration of routes and schedules in response to changing user constraints, which results in improved latency, scalability, and overall technical performance of the route-planning server.

The term “system” refers to a combination of hardware and software components including at least one server, at least one information processing terminal, and one or more external information processing apparatuses that cooperate to perform route planning and display processing.

The term “server” refers to an information processing apparatus including at least one processor, a communication interface, and a memory, the server being configured to execute route planning, prompt generation, AI interaction, and data integration processes.

The term “processor” refers to one or more hardware processing units, such as a central processing unit, a graphics processing unit, or a dedicated accelerator, capable of executing program instructions to perform the functions described in the claims.

The term “communication interface” refers to a hardware and software communication module that enables data transmission and reception between the server and external devices over a wired or wireless communication network.

The term “information processing terminal” refers to a user-operated computing device, such as a mobile terminal, a vehicle-mounted device, or a general-purpose computer, including at least a display device and an input device, and configured to communicate with the server.

The term “display device” refers to a component of the information processing terminal that presents visual information to a user, such as a liquid crystal display, an organic light-emitting display, or an equivalent visual output device.

The term “input device” refers to a component of the information processing terminal that receives input operations from a user, such as a touch panel, a keyboard, a pointing device, or a voice input module.

The term “user interface” refers to a graphical or interactive screen or set of screens presented by the display device of the information processing terminal that allows a user to input, modify, and confirm route planning parameters including at least a departure location and a destination location.

The term “departure location” refers to a geographic starting point of a planned route, which may be represented by a place name, an address, a facility name, or coordinate information.

The term “destination location” refers to a geographic end point of a planned route, which may be represented by a place name, an address, a facility name, or coordinate information.

The term “departure location data” refers to digital data representing the departure location in a form processable by the server, including at least one of a character string, a structured address representation, an identifier, or coordinate information.

The term “destination location data” refers to digital data representing the destination location in a form processable by the server, including at least one of a character string, a structured address representation, an identifier, or coordinate information.

The term “control instruction sentence” refers to a text expression generated by the processor that describes a requested route-search processing operation, including at least information identifying a departure location, a destination location, and a requirement for calculating a route.

The term “prompt sentence” refers to a text expression generated by the processor for input to a generative AI model, the text expression including at least a control instruction sentence and one or more conditions for generating route-related information.

The term “generative AI model” refers to a machine learning model implemented on an external information processing apparatus, the model being trained to generate text or structured data outputs in response to text prompts and being capable of producing route-related information based on the prompt sentence.

The term “external information processing apparatus” refers to a computing system separate from the server that executes the generative AI model and returns generated results to the server over a communication network.

The term “route-related information” refers to information generated by the generative AI model that includes at least intermediate location information arranged between a departure location and a destination location, movement time information between locations, and stay time information for locations.

The term “intermediate location information” refers to information identifying one or more locations to be placed between the departure location and the destination location along a planned route, the locations being represented by at least one of a place name, an address, a facility name, or a category.

The term “movement time information” refers to data indicating an estimated required time for movement between a pair of locations, such as between the departure location, intermediate locations, and the destination location.

The term “stay time information” refers to data indicating an estimated or recommended duration of stay at a particular location included in the route-related information.

The term “location name” refers to a textual identifier of a geographic place, such as a city name, a facility name, or a sightseeing spot name, included in the route-related information.

The term “location reference information database” refers to a data storage system or service that provides mapping between location names and corresponding position coordinate information.

The term “position coordinate information” refers to geographic coordinates, such as latitude and longitude values, or other standardized geographic identifiers, that represent a specific location on a map.

The term “external map information providing apparatus” refers to a computing system or service that provides map data, route calculation services, or related geographic information in response to requests from the server.

The term “route calculation request data” refers to digital data transmitted from the server to the external map information providing apparatus, the data including at least position coordinate information and a request to execute route-calculation processing.

The term “route-calculation processing” refers to a computational operation that determines a route between locations based on position coordinate information and optionally other constraints, outputting details such as distances and travel times.

The term “detailed route information” refers to information returned from the external map information providing apparatus that includes at least movement distance information and movement required time information for each section of a route between locations.

The term “movement distance information” refers to data indicating a distance to be traveled along a route segment between two locations.

The term “movement required time information” refers to data indicating an estimated travel time required to traverse a route segment between two locations.

The term “arrival time information” refers to data indicating an estimated arrival time at each location based on movement required time information and optional departure time or arrival time constraint information.

The term “departure time information” refers to data indicating an estimated or scheduled departure time from each location based on arrival time information and stay time information.

The term “arrival time constraint information” refers to data specifying one or more constraints on arrival times at a location, such as a latest allowable arrival time or a required arrival time window.

The term “time plan information” refers to data representing a schedule along a route, the schedule including at least arrival time information and departure time information for each location.

The term “route geometry information” refers to digital data that represents the geometric shape of a route on a map, such as polylines or segments connecting position coordinates.

The term “location display information” refers to digital data indicating how locations are to be visually represented on a map display device, including at least marker positions and optional visual attributes.

The term “map display device” refers to a display component of the information processing terminal that renders a map, route geometry information, and associated location display information for a user.

The term “regional specialty information” refers to information relating to region-specific products, cultural items, or services that are characteristic of a given geographic area.

The term “sightseeing information” refers to information relating to tourist attractions, scenic locations, historical sites, or other places of interest.

The term “dining information” refers to information relating to eating and drinking establishments, such as restaurants, cafes, or food markets, including at least their locations and characteristics.

The term “user preference conditions” refers to conditions specified by a user that influence route planning, including at least preferred categories of locations, desired types of stops, or travel style preferences.

The term “stop candidate location information” refers to information identifying potential locations that may be included as optional or recommended stops along a route between the departure location and the destination location.

The term “update condition information” refers to data received from the information processing terminal that indicates one or more new or modified constraints for route planning, including at least one of stop location type conditions, arrival time conditions, total movement time conditions, or stay time conditions.

The term “stop location type conditions” refers to conditions specifying desired types or categories of stop locations, such as hot springs, local specialty shops, sightseeing spots, or dining places.

The term “arrival time conditions” refers to conditions specifying desired or required arrival times at one or more locations, such as a latest arrival time or a target arrival time.

The term “total movement time conditions” refers to conditions specifying constraints on the total amount of time allowed for movement along a route, including maximum or target travel durations.

The term “stay time conditions” refers to conditions specifying constraints or preferences for durations of stay at one or more locations along the route.

The term “update prompt sentence” refers to a prompt sentence generated by the processor that includes update condition information and is input to the generative AI model to obtain updated route-related information.

The term “updated route-related information” refers to route-related information generated by the generative AI model in response to an update prompt sentence, reflecting one or more updated constraints or preferences.

The term “route display” refers to a visual representation of a calculated route, including at least the route geometry information and location display information, on the map display device of the information processing terminal.

In one embodiment, a server cooperates with a terminal and one or more external information processing apparatuses to implement a route-planning system utilizing a generative AI model. The server includes at least one processor, a memory storing program instructions and data structures, and a communication interface for network communication.

The terminal includes a display device and an input device and is configured to communicate with the server via a wired or wireless network.

The terminal provides a graphical user interface implemented by software such as a mobile operating system framework (for example, an Android framework or a generic mobile UI framework) or a web browser framework. The terminal displays input fields for a departure location and a destination location, and additional interface elements for specifying user preference conditions such as desired categories of stop locations, desired arrival time windows, and constraints on total travel time or stay time. The terminal sends user-entered data to the server in a structured format, such as a hierarchical object with fields for the departure location, the destination location, and constraint parameters.

The server receives the user-entered data via the communication interface and stores the data in the memory in association with a unique request identifier. The server uses data structures such as key-value maps and lists to represent location data, time constraints, and user preference conditions. The server validates the received data by checking non-emptiness of required fields, permitted character sets, and plausibility of time constraints. The server then constructs a control instruction sentence and a prompt sentence that describe a desired route-search processing operation to be performed by a generative AI model.

The server generates the prompt sentence according to a predefined template stored in the memory. For example, the server may generate a prompt sentence such as:

“Departure point: Tokyo. Destination: Osaka. Please propose the optimal driving route with several important waypoints. Consider regional specialties, sightseeing spots, and dining information. Output the result as structured text including an ordered list of waypoints, estimated travel time between waypoints, and recommended stay time at each waypoint.”

In another example, when time constraints are specified, the server may generate a prompt sentence such as:

“The departure point is Tokyo and the destination is Osaka. The user will depart at 9:00 AM and wants to arrive by 7:00 PM. Please generate an optimal time plan including recommended waypoints for local specialties, sightseeing, and lunch. Return an ordered list of stops with approximate arrival time, stay duration, and a brief description.”

The server embeds constraint parameters into the prompt sentence in a deterministic manner, rather than simply forwarding free-form user text. By doing so, the server standardizes the input to the generative AI model and reduces parsing ambiguity on the server side.

In one embodiment, the server uses a generative AI model implemented as a transformer-based neural network operated on an external information processing apparatus. The generative AI model is trained on a large corpus of text data including general language, geographic descriptions, and travel-related content. The model includes multiple layers of self-attention and feedforward sub-layers, each parameterized by weight matrices and bias vectors stored in the memory of the external apparatus. The model performs tokenization of the prompt sentence, converts tokens into vector embeddings, and applies the transformer layers to compute contextual representations. The model outputs a sequence of tokens representing a textual response that encodes route-related information.

The server configures the generative AI model by specifying parameters such as temperature, maximum token length, and output format constraints, using an application programming interface provided by the external information processing apparatus. The server transmits the prompt sentence and associated configuration data to the external apparatus via the communication interface, and receives the generated text response.

The server enforces a structured output convention by including explicit instructions in the prompt sentence, such as requiring that each waypoint be presented on a separate line with a specified field order, including a location name, an approximate location descriptor, an estimated movement time, an estimated stay time, and a description of the location type. This non-conventional prompt design causes the generative AI model to output results in a format that can be parsed deterministically, reducing the number of error-handling paths in the server program and improving processing speed.

The server parses the AI-generated text response using a state machine parser implemented in software stored in the memory. The server splits the text into lines, identifies field delimiters according to the instructed format, and constructs internal data objects representing each waypoint. Each waypoint object contains fields for a textual location name, category labels such as “regional specialty,” “sightseeing,” or “dining,” and quantitative time values. The server validates parsed values by checking numeric ranges for movement time and stay time, and by verifying that the departure and destination locations are included in the ordered list.

The server then converts the textual location names into geographic coordinates by referring to a location reference information database. In one embodiment, the server accesses an external map information service via a geocoding application programming interface. The server transmits queries containing location names and optional region hints, and receives coordinate data including latitude and longitude values. The server associates each waypoint object with corresponding coordinate data. If multiple candidate coordinates are returned for a given location name, the server applies disambiguation rules based on proximity to the line segment between the departure and destination, stored regional constraints, or previously known user preferences. By enforcing these rules in software, the server reduces the risk of mislocated waypoints and improves route accuracy.

After resolving coordinates, the server interacts with an external map information providing apparatus that offers route-calculation functionality. The server transmits route calculation request data including the coordinates of the departure location, intermediate waypoints, and the destination location. The external apparatus responds with detailed route information, such as polyline representations of the route segments, segment distances, and estimated travel times. The server stores the detailed route information in the memory together with the waypoint data and time values obtained from the generative AI model.

The server generates a time plan by combining the movement required time information from the external map apparatus with the stay time information from the generative AI model. The server uses a time arithmetic module implemented in software to add movement times and stay times to a reference departure time, thereby computing arrival times and departure times for each waypoint. When the user specifies arrival time constraints or maximum total movement time, the server checks whether the computed schedule satisfies these constraints. If constraints are violated, the server adjusts stay times according to predetermined rules or constructs a new prompt sentence that incorporates tighter constraints, such as:

“Departure: Tokyo. Destination: Osaka. The user must arrive in Osaka by 6:00 PM and the total driving time must not exceed 7 hours. Please shorten or remove some stops while still including at least one regional specialty location and one sightseeing spot.”

The server sends the updated prompt sentence to the generative AI model and receives an updated set of waypoints and time data, thereby iteratively refining the plan while reusing previously obtained coordinate and route information when possible.

The server generates route geometry information by encoding the polyline data from the external map apparatus into a format suitable for rendering on the terminal, such as a compact polyline encoding format. The server generates location display information by associating each waypoint coordinate with display attributes including marker type, color, icon shape, and label text. The server then transmits route geometry information, location display information, and time plan information to the terminal.

The terminal receives the data and uses a map display library or platform-specific graphics framework to draw the route and markers on the display device. The terminal displays the route as a polyline overlay on a base map, and displays markers at each waypoint with icons corresponding to the waypoint category. The terminal additionally presents a list or timeline showing the ordered waypoints, their arrival times, departure times, and descriptions. The user can select a waypoint via touch input, and the terminal responds by highlighting the marker and displaying detailed information about the location.

The terminal provides controls for the user to modify conditions, such as selecting additional categories like “hot spring” or tightening arrival time constraints. When the user changes conditions, the terminal constructs updated condition data and sends it to the server. The server receives update condition information and generates an update prompt sentence, explicitly describing the new constraints. For example, the server may generate:

“Departure point: Tokyo. Destination: Osaka. The user wants at least one hot spring and one local specialty restaurant, and the total travel plus stay time must not exceed 10 hours. Please propose a route and time schedule that satisfy these conditions.”

The server transmits this update prompt sentence to the generative AI model and processes the new route-related information as described above. The server reuses previously computed coordinate mappings and route segments when possible, thereby reducing the amount of external route calculation calls and decreasing network and processing load.

In one embodiment, the generative AI model is trained using supervised learning on a training dataset that includes pairs of input texts describing departure and destination locations and desired constraints, and output texts representing structured route descriptions and schedules. The external information processing apparatus stores training data in a data storage system and uses a training algorithm such as stochastic gradient descent with a cross-entropy loss function defined over token sequences. During training, the apparatus repeatedly updates the model's weight parameters by backpropagating the loss gradient through the transformer layers. The apparatus may employ techniques such as mini-batch training, learning rate scheduling, and gradient clipping to improve convergence stability.

The generative AI model learns to map input prompt sentences to structured route descriptions that respect the encoded constraints. The model's ability to understand complex relations between textual constraints and geographic patterns enables the server to delegate high-level combinatorial planning tasks to the model. By structuring the prompt sentence and output format, the server reduces the need for custom combinatorial optimization algorithms that would otherwise run on the processor, thereby reducing computational complexity.

The server achieves a technical improvement in computer operation by transforming unstructured user preferences and complex travel constraints into machine-parseable route-related information via the generative AI model, and by directly integrating such information with coordinate-based route-calculation services. This design reduces the number of custom heuristics and conditional branches in the route-planning program, which in turn reduces CPU cycles and memory usage. The server also reduces communication load with external map services by obtaining a smaller set of high-quality candidate waypoints from the generative AI model, rather than exhaustively querying large sets of candidate locations.

The server achieves improved accuracy in route planning because the generative AI model, trained on diverse travel descriptions, can propose intermediate locations and time allocations that more closely reflect realistic travel patterns. The subsequent coordinate resolution and route-calculation processing anchor these proposals in precise geographic data. The combination of statistical generative modeling and deterministic map routing yields plans that are both contextually rich and geometrically accurate.

The server improves the responsiveness of the system by caching intermediate results, such as coordinate mappings and route segments, and by using update prompt sentences to incrementally refine route-related information when the user changes constraints. This approach avoids complete re-execution of the route-search pipeline for each user modification, resulting in lower latency and better scalability under high user load.

In another embodiment, the server may use alternative generative AI models, such as encoder-decoder architectures or recurrent neural networks, trained with similar methods, provided that the models accept prompt sentences and output route-related information in a structure that the server can parse. The server may also use different external map information providing apparatuses, including open map services or proprietary navigation engines, as long as the apparatuses accept position coordinate information and output detailed route information.

In still another embodiment, the terminal may be a vehicle-mounted device integrated with vehicle control systems. The terminal can display the calculated route and time plan and may further provide route information to a vehicle control unit. In such a case, the server-generated route and time plan can be used to adjust driving profiles or charging schedules for an electric vehicle. The system thus extends beyond mere display of information and can influence the timing and control of physical vehicle operations.

By implementing the described architecture, the server, the terminal, and the external apparatuses cooperate to form a technical system in which route planning is not limited to static algorithmic computation but is instead realized by a structured interaction between a generative AI model and conventional geographic computation services. The resulting improvements in processing efficiency, accuracy, and adaptability demonstrate a concrete enhancement of computer technology itself, rather than a mere automation of human travel planning.

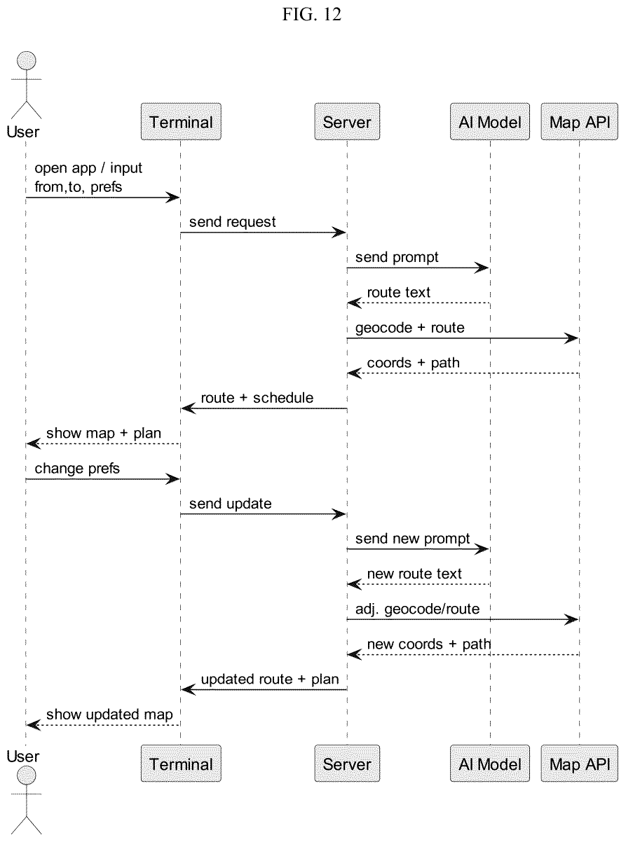

The following describes the processing flow using FIG. 12.

### Step 1:

The user operates the terminal to launch a route-planning application and to open a screen for route configuration. The input of this step is a user action (application start) and initial system state. The terminal loads UI layout data and localization strings from its local storage, instantiates UI components such as text fields for a departure location and a destination location, and renders them on the display device. The output of this step is a visible user interface that is ready to accept location and preference input from the user.

### Step 2:

The user uses the terminal's input device to enter a departure location, a destination location, and optional preference conditions such as desired categories of stop locations, desired arrival time, maximum travel time, or minimum stay time. The input of this step is raw user keystrokes or touch events. The terminal converts these events into character strings, assigns them to internal variables representing “departure,” “destination,” and “constraints,” and performs basic validation such as checking that required fields are not empty and that time values are in valid ranges. The output of this step is structured input data stored in the terminal's memory, typically as objects or key-value pairs ready to be transmitted.

### Step 3:

The terminal transmits the structured input data to the server over a communication network.

The input of this step is the set of validated departure location data, destination location data, and constraint data. The terminal serializes these data into a request format such as JSON, attaches metadata such as a client identifier and timestamp, and sends the serialized data to the server via an HTTPS POST request using a networking library. The output of this step is a network message delivered to the server, containing the user's route-planning request.

### Step 4:

The server receives the route-planning request and stores it in memory for processing. The input of this step is the serialized request data received through the communication interface. The server deserializes the data into internal data structures, verifies field presence and types, and assigns a unique request identifier. The server may write the request data and identifier into a database record for traceability. The output of this step is a validated internal representation of the planning request associated with a unique identifier.

### Step 5:

The server generates a control instruction sentence and a prompt sentence for the generative AI model based on the received request data. The input of this step is the internal representation of the departure location data, destination location data, and constraints. The server selects a template stored in memory and performs string substitutions to insert the concrete departure and destination, and, if present, time and category constraints. The server also appends explicit formatting rules for the expected output. For example, the server may generate a prompt sentence such as: “Departure point: Tokyo. Destination: Osaka. Please propose the optimal driving route with several important waypoints. Consider regional specialties, sightseeing spots, and dining information. Output the result as an ordered list of waypoints, each with location name, estimated travel time between waypoints, recommended stay time, and a short description.” The output of this step is a fully formed prompt sentence string ready to be transmitted to the generative AI model.

### Step 6:

The server sends the prompt sentence to the generative AI model running on an external information processing apparatus and receives route-related information. The input of this step is the generated prompt sentence and configuration parameters such as model name and maximum token length. The server uses an API client to package the prompt sentence and parameters into a model invocation request and transmits it via the communication interface. The external apparatus tokenizes the prompt, applies transformer layers to compute hidden representations, and generates a token sequence representing the response. The server receives the textual response from the external apparatus. The output of this step is a text response that encodes route-related information, such as a list of waypoints with approximate movement and stay times.

### Step 7:

The server parses the text response from the generative AI model into structured route-related data. The input of this step is the plain-text response containing ordered waypoint descriptions, movement time information, stay time information, and descriptions. The server applies a parsing procedure that splits the text into lines, identifies field separators according to the output format specified in the prompt, and extracts fields such as location name, category, travel time, and stay time. The server converts numeric fields from text to integer or floating-point types and validates their ranges. The output of this step is a collection of waypoint data structures stored in memory, each containing at least a location name, movement time, stay time, and description.

### Step 8:

The server resolves each waypoint's location name into geographic coordinates using a location reference information database or external geocoding service. The input of this step is the list of waypoint data structures with textual location names. The server sends each location name, optionally with region hints, to a geocoding service and receives candidate coordinate pairs. The server evaluates each candidate using rules such as geographic proximity to the line between the departure and destination or membership in an expected region. The server selects the most appropriate candidate and assigns the corresponding latitude and longitude to the waypoint data structure. The output of this step is an updated list of waypoint structures, each enriched with position coordinate information.

### Step 9:

The server obtains detailed route information from an external map information providing apparatus based on the coordinate-enriched waypoints. The input of this step is the ordered sequence of coordinates for the departure location, intermediate waypoints, and destination location. The server constructs route calculation request data specifying the origin, destination, and waypoints, and sends this request to the external map apparatus via the communication interface. The external apparatus computes a route over its road network and returns detailed route information including polyline geometry, segment distances, and estimated travel times. The output of this step is a detailed route dataset stored in the server's memory, aligned with the waypoint order.

### Step 10:

The server calculates a time plan by combining the detailed route information with stay time information from the generative AI model. The input of this step is the segment-by-segment travel time data from the external map apparatus and the stay time information embedded in the waypoint structures, together with an initial departure time or arrival time constraint. The server performs time arithmetic by summing travel and stay durations, computing arrival and departure times for each waypoint, and adjusting calculations to satisfy any arrival time or total travel time constraints. If constraints are violated, the server may apply heuristics to shorten stays or may mark the plan as inconsistent. The output of this step is time plan information specifying arrival and departure times for each waypoint.

### Step 11:

The server generates route geometry information and location display information for use by the terminal's map display device. The input of this step is the polyline geometry for the route, the waypoint coordinates, and the time plan information. The server encodes the route geometry into a compact representation, selects marker icons and colors based on waypoint categories, and constructs label strings that include location names and scheduled times. The server aggregates this data into a display-oriented structure, such as an object containing route geometry, waypoint markers, and associated textual labels. The output of this step is a render-ready dataset for the terminal.

### Step 12:

The server transmits the render-ready dataset to the terminal. The input of this step is the display-oriented structure containing route geometry information, location display information, and time plan information. The server serializes these data into a response format and sends them over the communication interface using an HTTP response. The output of this step is a network response message received by the terminal, containing all the data needed for route and schedule visualization.

### Step 13:

The terminal receives the render-ready dataset and displays the calculated route and time plan to the user. The input of this step is the serialized response from the server. The terminal deserializes the response into internal data structures, passes the route geometry to a map rendering component, and draws the polyline representing the route. The terminal places markers at each waypoint coordinate, using icons corresponding to categories such as sightseeing or dining, and overlays labels that show location names and times. The terminal additionally constructs a list or timeline view from the time plan information, showing ordered stops, arrival times, departure times, and descriptions. The output of this step is an interactive visual representation of the route and schedule on the display device.

### Step 14:

The user reviews the displayed route and time plan and may request modifications to constraints or preferences. The input of this step is the currently displayed route visualization and the user's assessment. The user interacts with the terminal by tapping markers, scrolling the timeline, or selecting buttons to change conditions, such as adding a desire to visit a hot spring or tightening the required arrival time. The terminal converts these interactions into updated condition data stored in internal variables. The output of this step is a set of updated conditions reflecting the user's new preferences.

### Step 15:

The terminal sends the updated condition data to the server to request a revised route. The input of this step is the updated condition data combined with the original departure and destination data. The terminal packages these into a new request, attaches the previous request identifier or a new identifier as needed, and transmits the request to the server over the communication interface. The output of this step is a modification request message received by the server.

### Step 16:

The server processes the modification request and generates an update prompt sentence for the generative AI model. The input of this step is the updated condition data and the stored context of the prior route request. The server constructs an update prompt sentence that explicitly describes the new constraints and may reference desired categories and time limits. For example, the server may generate: “Departure point: Tokyo. Destination: Osaka. The user wants at least one hot spring and one local specialty restaurant, and the total travel plus stay time must not exceed 10 hours. Please propose a route and time schedule that satisfy these conditions.” The server uses this text as a new prompt sentence. The output of this step is an updated prompt sentence string tailored to the modified constraints.

### Step 17:

The server sends the updated prompt sentence to the generative AI model, receives updated route-related information, and updates internal data structures accordingly. The input of this step is the updated prompt sentence and model configuration. The server transmits the updated prompt sentence to the external apparatus, receives a new textual response, and parses it into waypoint data structures using the same parsing logic as before. Where possible, the server matches new waypoints to previously resolved coordinates and route segments to reduce redundant computation. The output of this step is a revised set of waypoint data and associated times reflecting the new user constraints.

### Step 18:

The server recalculates or adjusts the route and time plan based on the updated route-related information and produces a new render-ready dataset. The input of this step is the revised waypoint list, coordinate mappings, detailed route information, and stay times. The server updates the sequence of waypoints, requests additional route calculations if new segments are needed, recomputes arrival and departure times, and regenerates route geometry and location display information. The output of this step is an updated display-oriented structure, which the server transmits to the terminal for re-rendering, resulting in a revised route and schedule presented to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional travel planning systems typically implement route search and point-of-interest recommendation as a set of independent functions that operate on static geographical databases. A server generally computes a route between a departure location and a destination location, and then retrieves nearby points of interest using simple filtering rules based on distance or category. Such systems suffer from several technical limitations in how they process and organize route-adjacent information on computing resources. For example, conventional servers often execute repetitive, coarse-grained database queries over large geographic regions, resulting in redundant retrieval of irrelevant records, inefficient use of memory, and increased processing latency. Furthermore, recommendation logic is frequently implemented as fixed rule-based code that does not adaptively re-rank or refine candidate locations based on context, which forces the server to either over-retrieve and post-filter large result sets or under-retrieve and omit potentially relevant candidates.

In addition, when external machine learning services or generative models are used, they are often treated merely as black-box text generators. Existing architectures commonly pass free-form query text to a generative model and directly display the returned text to a user without integrating the generated content with structured route and database data. This decoupled usage prevents the server from systematically leveraging the generative model to improve internal data structures, such as evaluation indices and route-aware rankings, and leads to ambiguities when model outputs do not correspond cleanly to database entries. As a result, the system cannot reliably map generated recommendations back to concrete records, and cannot programmatically update its route computation or candidate selection pipeline in a consistent, machine-interpretable manner.

Moreover, typical itinerary generation workflows merely append a narrative description layer on top of precomputed plans, without allowing the itinerary-generation logic to be driven by structured schedule data and mandatory stopover constraints. The server therefore misses an opportunity to use generative models as part of a feedback loop that refines the plan based on the actual structure of the route, estimated travel times, and stay durations. This architectural separation between structured computation and generative processing leads to increased complexity in application logic, duplicated data processing paths, and difficulty in maintaining consistent state across subsystems.

Accordingly, there is a need for a computer-implemented travel planning system in which a server coordinates route calculation, route-adjacent information retrieval, candidate location extraction, and itinerary generation in a unified data flow. The system should utilize a structured representation of the route and surrounding regions to narrow the search space, should programmatically integrate generative AI outputs with structured data by using prompt sentences that embed identification and attribute information, and should use the generative AI outputs to adjust machine-readable evaluation indices and schedule structures. By doing so, the server can reduce redundant computations, improve ranking precision, and generate travel plans that are both contextually rich and computationally grounded, thereby improving the overall functioning and efficiency of the computer system itself.

The specific processing by the specific processing unit 290 of the data processing device 12 in Example 2 is realized by the following means.

The present invention provides a server comprising a processor configured to provide an information input/output interface to receive a departure location and a destination location from a user, to acquire position information corresponding to the departure location and the destination location, to generate route information between the departure location and the destination location based on the position information, to identify a route-surrounding region corresponding to the route information, to retrieve from a structured information set stored in an external storage device sightseeing-related information, regional specialty-related information, and dining-related information included in the route-surrounding region, to extract candidate stopover locations by evaluating the retrieved information based on a positional relationship with the route information and on an evaluation index, and to present the candidate stopover locations to the user, the processor further configured to receive a selection of at least a part of the candidate stopover locations as mandatory stopover locations, to update the route information based on the selection, and to generate travel plan information including the mandatory stopover locations, the processor further configured to generate a prompt sentence for input to a generative AI model based on information relating to the departure location, the destination location, and the candidate stopover locations, to include identification information and attribute information of the candidate stopover locations in the prompt sentence, to input the prompt sentence to the generative AI model, to analyze output information obtained from the generative AI model by comparing location names or region names in the output information with the structured information set to specify corresponding location identification information, to correct or extend the candidate stopover locations or the travel plan information and to update the evaluation index of the candidate stopover locations based on the specified location identification information, and to output, via the information input/output interface, the travel plan information including a result of the correction or extension and itinerary description information associated with time schedule information generated from the updated route information and estimated travel and stay times. This enables the server to narrow the retrieval space to route-adjacent regions, to maintain a consistent structured representation of candidate locations and schedules, to use the generative AI model in a closed computational loop that programmatically refines evaluation indices and itinerary data, and thereby to improve the efficiency, accuracy, and responsiveness of computer-implemented travel planning processing.

The term “departure location” refers to a geographical place at which a user intends to start a travel, the place being represented in the system as text, coordinates, or another machine-interpretable location identifier.

The term “destination location” refers to a geographical place at which a user intends to end a travel, the place being represented in the system as text, coordinates, or another machine-interpretable location identifier.

The term “position information” refers to data representing a location in a coordinate space, including, for example, latitude and longitude, grid coordinates, or other numerical data that allow a computing device to identify a place on or relative to a map.

The term “route information” refers to structured data representing a travel path between at least two locations, the structured data including, for example, an ordered list of waypoints, a polyline, segment distances, and estimated travel times for respective segments.

The term “route-surrounding region” refers to a spatial region defined with respect to route information, the spatial region including at least an area lying within a predetermined distance from one or more segments of the route.

The term “structured information set” refers to a collection of records stored in a machine-readable format, such as relational tables or key-value entries, each record including predefined fields such as identifiers, attributes, and location data, and being retrievable using queries.

The term “external storage device” refers to a data storage resource that is accessible to a server via a communication interface and that is distinct from volatile main memory, including, for example, a database system, a non-volatile memory device, or a network-attached storage system.

The term “sightseeing-related information” refers to structured data describing places of interest for visitors, including, for example, identifiers, names, categories, descriptions, and location data for landmarks, scenic spots, museums, and similar attractions.

The term “regional specialty-related information” refers to structured data describing goods or services characteristic of a particular region, including, for example, identifiers, names, categories, descriptions, and location data for local products, specialty foods, and traditional crafts.

The term “dining-related information” refers to structured data describing eating and drinking facilities or offerings in a region, including, for example, identifiers, names, categories, menus, descriptions, and location data for restaurants, cafes, and similar establishments.

The term “candidate stopover location” refers to a location identified by the system as a potential point for a user to stop during travel, the location being derived from sightseeing-related information, regional specialty-related information, or dining-related information and associated with route information.

The term “mandatory stopover location” refers to a candidate stopover location that has been selected by a user or automatically designated by the system as a required point to be included in a travel path between a departure location and a destination location.

The term “evaluation index” refers to one or more numerical or categorical values assigned to a candidate stopover location to indicate its relative suitability or priority for inclusion in a travel plan, the values being computed based on factors such as distance from a route, popularity, category, and user preference.

The term “travel plan information” refers to structured data representing an arrangement of one or more travel segments and stops, including, for example, a sequence of locations, associated route information, and optionally scheduled times, stay durations, and associated descriptive information.

The term “time schedule information” refers to structured data that associates locations or segments in a travel plan with temporal values, including, for example, estimated departure times, arrival times, and stay durations for respective stopover locations.

The term “information input/output interface” refers to a hardware and/or software component configured to receive data from and output data to a user or another system, including, for example, a graphical user interface, an application programming interface, or a communication interface.

The term “prompt sentence” refers to text data generated for input to a generative AI model, the text data including instructions, constraints, and optionally identification information and attribute information that guide the generative AI model in producing output relevant to travel planning.

The term “generative AI model” refers to a machine-implemented model that generates output data, such as natural-language text, in response to input data including a prompt sentence, the model being trained using machine learning techniques to infer patterns from data.

The term “output information obtained from the generative AI model” refers to data generated by a generative AI model in response to a prompt sentence, including, for example, natural-language text that describes recommended locations, explanations, or itinerary content.

The term “identification information” refers to data that uniquely or quasi-uniquely identifies an entity within a structured information set, including, for example, an identifier for a location, record, or object used by a database or other data structure.

The term “attribute information” refers to data describing properties or characteristics of an entity, including, for example, a category, name, description, rating, or other descriptive field associated with a location or record.

The term “location identification information” refers to identification information specifically associated with a geographical location or a record representing the geographical location within a structured information set.

The term “itinerary description information” refers to natural-language text that describes a travel plan, including, for example, a sequence of visits, time indications, and reasons or comments related to respective stopover locations.

In one embodiment, a server cooperates with a terminal operated by a user to generate, refine, and present a travel plan including mandatory stopover locations between a departure location and a destination location. The server executes a computer program on a computing platform such as a general-purpose server machine including at least one central processing unit, a main memory, a non-volatile storage device, and a network interface. The server runs an operating system such as a UNIX-like operating system and an application framework such as a web application framework. The terminal includes a processing unit, a display, an input device, and a communication interface, and runs an operating system such as a mobile operating system and a browser or native application.

The server executes an application program that is stored in the non-volatile storage device and loaded into the main memory. The server program is implemented, for example, using a high-level programming language executing on an application server environment. The server program communicates with a relational database management system, such as a relational database engine running on the same server or on a separate database server. The database stores structured information sets including sightseeing-related information, regional specialty-related information, and dining-related information.

The server uses a database schema including tables such as a location table, a spot table, and a plan table. The location table stores fields such as location_id, latitude, longitude, and region_code. The spot table stores fields such as spot_id, location_id, category_code, name_text, description_text, base_popularity_score, and attribute_vector. The plan table stores fields such as plan_id, user_id, departure_location_id, destination_location_id, and metadata fields. A separate plan_stop table stores plan_id, spot_id, sequence_index, estimated_arrival_time, and estimated_stay_duration. These structures allow the server to access and update travel plan information using indexed queries, thereby reducing scan ranges and improving access latency compared to unstructured storage.

The terminal executes a user interface program that presents an information input/output interface. The terminal displays input fields for a departure location and a destination location, and displays lists and detailed views of candidate stopover locations and final travel plans. The terminal uses a graphical user interface toolkit and sends and receives data with the server via a communication protocol such as HTTP over a secure transport. The user operates the terminal to input text strings representing the departure location and the destination location, such as “Tokyo” and “Osaka”.

The server receives the user input from the terminal and converts the textual departure and destination into position information by calling a geocoding service. The server sends a request to a geocoding module, which may be implemented as a software library or as a network service, and receives latitude and longitude pairs. The server stores these coordinates in memory as structured data, for example as floating-point values associated with a departure_location_id and a destination_location_id.

The server uses a routing engine, such as a navigation library or an external routing service, to generate route information between the departure location and the destination location. The routing engine returns an ordered list of waypoints represented as coordinate pairs and associated segment distances and estimated travel times. The server stores the route information in an in-memory data structure such as an array of route_segment records, each record including a segment_start_coordinate, a segment_end_coordinate, a segment_length, and an estimated_travel_time_value. The server may also store encoded polylines in a compact string representation for efficient transmission to the terminal.

The server identifies a route-surrounding region by computing a buffer area around each route segment. The server uses a geometric computation library to compute, for each segment, a corridor region defined by a maximum lateral distance from the segment, and then computes a union region that encompasses all such corridors. The server determines a minimum bounding rectangle or a tiling of grid cells that cover the union region. The server thereby converts the continuous geometry into discrete spatial indices, such as region tiles or grid identifiers, which can be used in database queries to filter relevant records. This approach reduces the number of records that must be scanned compared to naive distance checks on all stored spots.

The server queries the database to retrieve sightseeing-related information, regional specialty-related information, and dining-related information stored in the structured information set. The server issues queries that specify spatial constraints based on the route-surrounding region, category constraints, and possibly user profile constraints. For example, the server specifies a condition that the location_id of a spot must be included in a set of region tiles intersecting the route-surrounding region. The database uses indices on region_code, category_code, and popularity fields to efficiently retrieve a subset of candidate spots. This reduces memory usage and computation time and contributes to a technical improvement in data management and retrieval.

The server loads the retrieved records into memory and constructs candidate stopover location objects. Each object includes a spot_id, coordinates, a base_popularity_score, a category_code, and an attribute_vector. The attribute_vector may encode normalized numerical attributes such as user rating, expected crowd level, typical visit duration, and distance from the main route. The server computes an evaluation index for each candidate stopover location using a weighted combination of features. For example, the server calculates a score as a linear combination of normalized distance from the route, normalized popularity, and category priority. The server may store these scores in a dedicated field of the candidate object. This computational process is executed in a vectorized manner to minimize CPU cache misses and to maximize throughput.

The server selects a subset of candidate stopover locations based on the evaluation indices.

The server sorts the candidates by score using an efficient sorting algorithm and may further apply diversity constraints such as limiting the number of spots per region or per category.

The server thereby generates a list of candidate stopover locations that are likely to be relevant for the user. The server sends the candidate information to the terminal for presentation. The terminal displays the list with names, categories, and short descriptions.

The user operates the terminal to select one or more candidate stopover locations as mandatory stopover locations, for example by tapping on “Nagoya's famous eel” or “Kiyomizu-dera in Kyoto”.

The server receives the mandatory stopover selections from the terminal and updates the route information. The server calls the routing engine again, this time specifying the mandatory stopover locations as intermediate waypoints between the departure and destination. The routing engine returns a new ordered list of waypoints and segment times for a route that passes through the mandatory stopover locations. The server updates the plan table and the plan_stop table with the new route and stop sequence and computes estimated arrival times and stay durations. The server thereby generates time schedule information that includes, for each segment and stop, a start time, an end time, and an estimated stay duration. In order to refine the set of candidate stopover locations and to generate richer descriptions, the server uses a generative AI model. The server employs a model such as a transformer-based neural network, which is trained offline using a large corpus of text and optionally structured travel data. The model architecture includes multiple layers of self-attention blocks, feedforward networks, and normalization layers. Each layer contains weight matrices and bias vectors that are adjusted during training using stochastic gradient descent or a related optimization method with back-propagation. The model uses a tokenization scheme to convert prompt sentences into sequences of token indices. During training, the model computes a loss function, such as a cross-entropy loss between predicted token distributions and target tokens, and updates the weights based on gradients. The training data may be augmented using techniques such as random masking of tokens, shuffling of explanatory clauses, or synthetic recombination of travel descriptions, which improves robustness and generalization.

The server uses the generative AI model at inference time as a component in a closed computational loop rather than as a passive text generator. The server constructs a prompt sentence that embeds structured information such as the departure location, the destination location, and identifiers and attributes of candidate stopover locations. For example, the server may generate a prompt sentence as follows:

“From Tokyo to Osaka, recommend the most attractive tourist spots, local specialties, and dining options along the route. Here are candidate spots: Nagoya-famous grilled eel restaurant, Kyoto-historic Kiyomizu temple. Please select the best ones and explain why.”

In another example, the server may generate a prompt sentence:

“Create a friendly, concise itinerary for a trip from Tokyo to Osaka including stops at Nagoya for eel and Kiyomizu-dera in Kyoto. Include approximate times and short descriptions.”

The server encodes the prompt sentence into tokens and sends the token sequence to the generative AI model. The model computes attention scores over tokens, propagates activations across layers, and outputs probability distributions for subsequent tokens. The server decodes the generated tokens into text, which constitutes output information. Because the prompt sentence includes explicit identifiers and structured attributes, the output text tends to reference candidate stopover locations in a consistent manner that can be algorithmically parsed.

The server analyzes the output information obtained from the generative AI model using text processing modules. The server uses string matching, regular expressions, and optionally a lightweight named entity recognition module to identify location names and region names in the generated text. The server then maps each extracted name to a record in the structured information set by comparing the name_text and region_code fields and by computing similarity metrics, such as edit distance or cosine similarity over character n-grams. The server thereby specifies location identification information, such as spot_id values, corresponding to the generated recommendations. The server uses these mappings to adjust evaluation indices of candidate stopover locations, for example by increasing the scores of spots that are explicitly recommended by the generative AI model or by decreasing the scores of spots that are not mentioned.

This feedback loop, in which the server feeds structured identifiers into the generative AI model and then uses the model's output to update structured evaluation indices, provides a technical improvement over systems that merely display generated text. The server improves the ranking precision and reduces subsequent query sizes because later retrieval operations can focus on a smaller set of high-confidence candidates. In addition, the server avoids ambiguity by grounding the generated recommendations in database identifiers. As a result, the system reduces processing time for subsequent requests and decreases memory usage and network traffic.

The server uses the generative AI model also to produce itinerary description information that corresponds to time schedule information. The server constructs prompt sentences that encode schedule structure, including departure times, arrival times, stay durations, and mandatory stopover locations. For example, the server may generate the following prompt sentence:

“Given a route from Tokyo to Osaka with stops in Nagoya for eel and Kiyomizu-dera in Kyoto, write a one-day travel itinerary including estimated times and reasons to visit each spot.”

The server passes, together with the prompt sentence, structured tokens representing times and sequence indices. The model, which has been fine-tuned using training data that pairs structured schedule vectors with narrative descriptions, learns to respect the order and approximate times in its output. The server aligns the generated itinerary description segments with corresponding entries in the time schedule information based on markers or tags embedded in the prompt. The server stores the aligned itinerary description in association with the plan_id, such that the terminal can display a coherent narrative synchronized with the structured schedule.

The server's cooperation with the generative AI model is not a mere replacement of human text drafting. The server uses non-conventional data flows and rules that are not typical of manual itinerary writing. The server enforces that the generative AI model operates within constraints derived from route-surrounding regions, spatial buffers, and evaluation indices.

The server also uses multiple passes of model interaction, in which an initial prompt elicits high-level spot preferences and a subsequent prompt refines narrative details for already determined mandatory stopover locations. This multi-stage, machine-controlled procedure reduces variance in outputs and allows the server to systematically adjust internal data structures in response to generative outputs.

The terminal receives the travel plan information and itinerary description information from the server and presents them to the user. The terminal displays the sequence of locations, times, and descriptions and may display the route on a map. The user can further modify selection preferences on the terminal, and the server again updates route information and evaluation indices. Because the server maintains consistent structured representations of the route, spots, and schedule, the system can quickly recompute effects of modifications without repeating full database scans.

In an alternative embodiment, the server executes the generative AI model locally on a hardware accelerator such as a graphics processing unit. The server loads the trained model parameters into GPU memory and executes the attention and feedforward computations using highly parallel matrix operations. This reduces inference latency compared to remote model invocation and allows the server to adapt prompt structures dynamically based on instantaneous load or user interaction patterns. The server may implement caching of intermediate token representations for frequently requested prompt templates, thereby further improving computation efficiency.

In another embodiment, the server uses a hybrid ranking mechanism in which a non-neural heuristic scoring function is combined with an embedding-based similarity measure computed from representations produced by an encoder network derived from the generative AI model. The server computes a dense vector for each spot's description and for the prompt describing the user's preferences. The server then computes cosine similarity between vectors and incorporates this similarity into the evaluation index. This procedure enables the server to capture semantic relationships beyond simple keyword matching, resulting in more accurate candidate selection. At the same time, the server constrains the embedding computations to the route-surrounding region, which avoids unnecessary computation for irrelevant regions. Because the server structures data and processing in this way, the system achieves technical effects beyond automation of human tasks. The server reduces the number of records processed by using geometric buffering and indexed region-based queries. The server improves ranking accuracy and stability by combining deterministic evaluation indices with generative model feedback. The server reduces total response time by avoiding redundant external calls and by using inference-time optimizations such as prompt caching and token reuse. The server reduces network traffic by sending only curated candidate sets and structured identifiers rather than unfiltered raw database dumps. These improvements are tied to specific system architecture and algorithms and do not arise from mere computerization of a manual workflow.

The described embodiments may be modified in various ways without departing from the scope of the invention. For example, the terminal may be implemented as a vehicle-mounted navigation device instead of a handheld device, and the server program may be executed partially on the terminal in an edge computing configuration. The structured information set may include additional categories such as lodging or event information, and the evaluation index computation may include additional features such as estimated fuel consumption or accessibility ratings. The generative AI model may be replaced with another sequence generation architecture, such as a recurrent neural network with attention, provided that the server continues to embed structured identifiers in prompt sentences and to map model outputs back to database records. In each case, the server, the terminal, and the user cooperate according to the described data structures and processing flows to implement the invention.

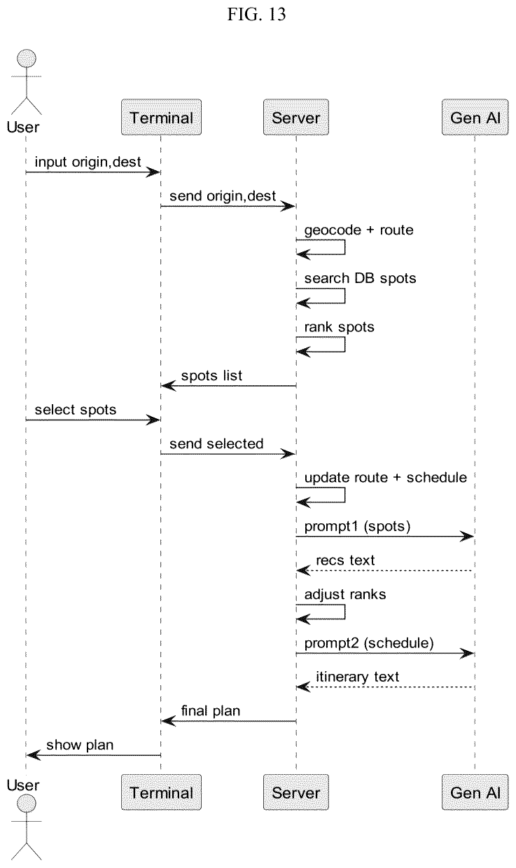

The following describes the processing flow using FIG. 13.

### Step 1:

User operates the terminal to launch a travel planning application and to input a departure location and a destination location.

Input: User-provided text strings representing the departure location and the destination location (for example, “Tokyo” and “Osaka”).

Output: A structured request payload, such as a key-value set containing the departure and destination, prepared for transmission to the server.

Terminal displays input fields, receives keystrokes or touch input, performs basic validation (non-empty, character set check), and converts the entered text into an internal data structure. Terminal then encapsulates this data in a request message and sends the message to the server via a network interface.

### Step 2:

Server receives the request payload containing the departure location and the destination location from the terminal.

Input: The request payload transmitted by the terminal, including departure and destination text strings and optional user profile identifiers.

Output: Normalized location query strings suitable for geocoding, and logging records representing the received request.

Server parses the incoming message, extracts the text values, and stores request metadata (timestamp, terminal identifier) in a log. Server sanitizes the text (for example, trimming whitespace, normalizing character encoding) and generates normalized strings that will be used as input to a geocoding module.

### Step 3:

Server converts the departure and destination text strings into position information using a geocoding process.

Input: Normalized departure and destination text strings generated in Step 2.

Output: Position information for the departure and destination, such as latitude and longitude values and associated location identifiers.

Server calls a geocoding service or library with each text string, receives candidate coordinates, and selects the most appropriate coordinate pair based on confidence scores or ranking provided by the geocoding service. Server then constructs location objects including coordinates and assigns internal location identifiers to these objects.

### Step 4:

Server generates route information between the departure location and the destination location using a routing engine.

Input: Position information for the departure and destination locations obtained in Step 3.

Output: Route information including an ordered list of waypoints, segment distances, and estimated travel times.

Server invokes a routing component with the start and end coordinates and a specified travel mode. The routing component returns a path represented as a sequence of coordinate pairs and associated travel metadata. Server converts this path into an internal route data structure, computing and storing for each segment the segment length and an estimated travel time based on routing engine output.

### Step 5:

Server identifies a route-surrounding region based on the generated route information.

Input: Route information including waypoints and segment geometry produced in Step 4.

Output: Geometric representation of a route-surrounding region and a discrete set of region identifiers or grid cells covering that region.

Server uses a geometric computation routine to compute a buffer around each route segment at a predetermined lateral distance. Server then unifies these buffers into a single contiguous region and calculates a minimal set of bounding rectangles or grid indices that cover this region. Server stores these region identifiers as filters for subsequent database queries.

### Step 6:

Server retrieves candidate spots from a structured information set stored in a database based on the route-surrounding region.

Input: Region identifiers or grid cells derived in Step 5 and category constraints for sightseeing, regional specialties, and dining.

Output: A set of database records representing candidate spots with their attributes and location data.

Server constructs database queries that restrict records to those whose location identifiers correspond to the route-surrounding region and whose categories match predetermined codes. Server sends the queries to the database engine, which uses indices to scan only relevant partitions. Server receives result tuples containing spot identifiers, coordinates, category codes, base popularity scores, and descriptive fields.

### Step 7:

Server computes evaluation indices for the retrieved candidate spots and selects candidate stopover locations.

Input: Candidate spot records obtained from the database in Step 6 and route information obtained in Step 4.

Output: A ranked list of candidate stopover locations with associated evaluation indices. Server calculates, for each spot, a distance from the closest route segment using the spot's coordinates and the stored route geometry. Server normalizes this distance and combines it with the base popularity score and category priority values using a mathematical scoring function. Server assigns a numeric evaluation index to each spot and sorts the spots by this index. Server then selects a subset of top-ranked spots as candidate stopover locations and stores them in a candidate list.

### Step 8:

Server prepares candidate stopover information and transmits it to the terminal for presentation.

Input: Ranked list of candidate stopover locations from Step 7.

Output: Response payload containing candidate stopover locations and their attributes for display on the terminal.

Server converts each candidate object into an output record including name, category, short description, coordinates, and evaluation index. Server aggregates these records into a structured response message and sends the message to the terminal via the network interface.

### Step 9:

Terminal displays candidate stopover locations to the user and accepts selections of mandatory stopover locations.

Input: Response payload containing candidate stopover locations received from the server in Step 8.

Output: A selection payload including identifiers of candidate stopover locations chosen by the user as mandatory stopover locations.

Terminal parses the received data and renders a list or map view showing each candidate's name, category, and description. User interacts with the terminal by selecting checkboxes or buttons associated with desired locations. Terminal collects the identifiers of selected candidates and encapsulates them into a selection payload, which is then transmitted to the server.

Step 10:

Server updates the travel plan by integrating the mandatory stopover locations into the route.

Input: Selection payload containing identifiers of mandatory stopover locations received in Step 9 and the original route information from Step 4.

Output: Updated route information and preliminary travel plan information including mandatory stopover locations.

Server retrieves full records for the selected spots from the database using their identifiers.

Server invokes the routing engine with the departure, the mandatory stopover locations in a specified or optimized sequence, and the destination to compute a new route that passes through all mandatory locations. Server constructs an updated route structure and a preliminary travel plan that includes ordered stops and segments.

### Step 11:

Server generates time schedule information for the updated travel plan.

Input: Updated route information from Step 10 and default or user-defined stay durations for each mandatory stopover location.

Output: Time schedule information including estimated departure and arrival times and estimated stay durations at each stop.

Server calculates, for each segment, an estimated travel time using routing engine outputs and accumulates these times along the route to determine arrival times at each stop. Server adds stay duration values at each mandatory stopover location to compute departure times from each stop. Server packages these times into a schedule data structure linked to the travel plan.

### Step 12:

Server generates a first prompt sentence for a generative AI model to refine candidate stopover locations and descriptive information.

Input: Data representing the departure location, the destination location, and attributes and identifiers of the candidate stopover locations from Step 7.

Output: A prompt sentence text string that encodes route context and candidate stopover details.

Server concatenates textual descriptors of the route and candidate spots into a coherent instruction sentence. For example, server may produce the following prompt sentence: “From Tokyo to Osaka, recommend the most attractive tourist spots, local specialties, and dining options along the route. Here are candidate spots: Nagoya-famous grilled eel restaurant, Kyoto-historic Kiyomizu temple. Please select the best ones and explain why.” Server includes, in hidden or structured form within the prompt or associated metadata, identifiers and attributes that can be used later to align generated text with database records.

### Step 13:

Server inputs the first prompt sentence to the generative AI model and analyzes the resulting output information to adjust evaluation indices.

Input: First prompt sentence generated in Step 12 and internal identifiers for candidate stopover locations.

Output: Updated evaluation indices for candidate stopover locations based on generative AI output.

Server encodes the prompt sentence into tokens and submits the token sequence to the generative AI model. The model computes attention and feedforward operations layer by layer and outputs a token sequence representing natural-language recommendations. Server decodes the tokens into text and then performs text analysis to detect mentions of location names or regions. Server maps these mentions to specific candidate stopover identifiers by comparing generated names with stored spot names and regions. Server increases evaluation indices for candidates explicitly supported by the generative AI output and may decrease indices for those not mentioned, thus producing a refined ranking.

### Step 14:

Server generates a second prompt sentence for the generative AI model to create itinerary description information aligned with the time schedule.

Input: Time schedule information from Step 11 and attributes of mandatory stopover locations from Step 10.

Output: A second prompt sentence text string encoding schedule structure and stop attributes. Server constructs a detailed instruction sentence that includes the ordered sequence of stops and approximate times. For example, server may generate the following prompt sentence: “Create a friendly, concise itinerary for a trip from Tokyo to Osaka including stops at Nagoya for eel and Kiyomizu-dera in Kyoto. Include approximate times and short descriptions.”

Server may embed markers or tags associated with each stop in the prompt so that segments of the generated description can be correlated back to specific stops in the schedule.

### Step 15:

Server inputs the second prompt sentence to the generative AI model and generates itinerary description information.

Input: Second prompt sentence generated in Step 14 and structured schedule markers.

Output: Itinerary description information in natural-language text aligned with the time schedule information.

Server passes the tokenized prompt to the generative AI model, receives generated output tokens, and decodes them into text describing the itinerary. Server uses embedded markers or inferred structure to split the text into segments associated with respective stops or time ranges. Server then associates each text segment with corresponding entries in the time schedule information, thereby forming a combined representation of structured times and narrative descriptions.

### Step 16:

Server assembles final travel plan information and transmits it to the terminal.

Input: Updated route information, refined evaluation indices, time schedule information, and itinerary description information generated in Steps 10 to 15.

Output: A final travel plan payload containing structured plan data and associated narrative text for presentation to the user.

Server merges the updated route, mandatory stopover sequence, schedule times, and narrative segments into a unified data object identified by a plan identifier. Server stores this object in the database and generates a response message that includes necessary fields for rendering on the terminal. Server sends the response message to the terminal over the network.

### Step 17:

Terminal displays the final travel plan and itinerary description to the user.

Input: Final travel plan payload received from the server in Step 16.

Output: A graphical presentation of the plan on the terminal display and, optionally, further user feedback or modification requests.

Terminal parses the payload and renders an ordered list of travel segments and stopover locations with associated times and textual descriptions. Terminal may overlay the route on a map view and allow the user to scroll through the narrative. User can then approve the plan or adjust parameters, and terminal can send additional modification requests to the server based on further interactions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented route guidance and travel planning systems are typically designed as static, rule-based applications that compute a shortest or fastest route between a departure point and a destination, optionally overlaying predefined points of interest. Such systems exhibit several technical limitations.

First, the core routing and scheduling engines generally operate on fixed, structured inputs, and are not able to robustly interpret free-form user instructions, complex user preferences, or dynamically changing constraints. When a user expresses requirements in natural language, conventional systems require manual parameter mapping or rigid, form-based input. This leads to under-utilization of available computing resources, because a large amount of contextual information (for example, text describing desired activities, time windows, and qualitative preferences) is not efficiently converted into machine-readable data for downstream optimization. As a result, the underlying computing system cannot adaptively reconfigure its data flows and optimization processes based on rich user input.

Second, traditional systems do not tightly integrate generative artificial intelligence models into the core route optimization pipeline in a way that structurally alters how the computing system selects candidate locations and constructs time schedules. Generative models, if used at all, are often attached only as a superficial presentation layer (for example, for generating travel descriptions), without influencing the internal selection of recommended points or the computation of schedule data. Consequently, the processor cannot exploit the generative model as a programmable, context-sensitive controller for constructing prompts, interpreting outputs, and iteratively improving the internal data structures that drive route and schedule computation.

Third, most existing systems treat the user state as static and do not incorporate real-time emotion information obtained from sensors such as cameras, microphones, or wearable devices. The computing pipeline generally ignores low-level sensor data that could be transformed into emotion labels, and thus lacks any feedback mechanism for dynamically changing the set of recommended locations, stay durations, or visiting order. This results in a rigid execution of a precomputed plan, and the processor cannot reallocate computational resources or recompute time schedule data in response to changing user conditions.

Fourth, existing architectures do not provide a unified mechanism to orchestrate multiple heterogeneous components—map information services, route search engines, external travel—time providers, emotion recognition models, and generative AI models—through explicit prompt sentences and structured data exchanges. In many implementations, each component is invoked in an ad hoc manner, which complicates the synchronization of intermediate data, increases latency due to redundant calls, and makes it difficult to maintain a clear, programmable flow of instructions. This leads to inefficient use of memory and processor cycles, and hampers the scalability of the system for supporting complex, multi-point, and real-time adjusted schedules.

Therefore, there is a need for an improved computer-implemented system and server architecture that:
(1) programmatically converts free-form user input into structured data usable by route search and optimization algorithms;
(2) uses a generative AI model, controlled via carefully constructed prompt sentences, as an integral part of selecting recommended points and generating time schedule data;
(3) acquires and analyzes user emotion information from sensor data and dynamically regenerates schedule data based on the detected emotion; and
(4) coordinates external map and route information services, user preference data, emotion data, and generative AI model outputs in a unified processing pipeline. Such a system should improve the functioning of the computer itself by enabling more adaptive data flows, more efficient execution of optimization processes, and more flexible, real-time modification of the route and schedule without manual reconfiguration of the software components.

The specific processing by the specific processing unit 290 of the data processing device 12 in Application Example 2 is realized by the following means.

The present invention provides a server comprising a processor configured to acquire, from a user device, input information including at least a departure point and a destination, to generate a user interface for setting the departure point and the destination based on the input information, and to obtain position coordinates corresponding to the departure point and the destination by referring to a map information storage unit storing geographic information; to generate an instruction text for causing an external route search process to be executed and to obtain basic route information from the departure point to the destination by causing the external route search process to be executed based on the instruction text; to refer to a point information storage unit storing point information including sightseeing point information and dining point information, and to extract candidate points existing within a predetermined range of the basic route based on the basic route information and the point information; to refer to a user history information storage unit and a user attribute information storage unit, to acquire preference information and constraint condition information of a user, and to generate candidate point data by adding the preference information and the constraint condition information to the candidate points; to generate text data including the candidate point data, the departure point, the destination, and the preference information and the constraint condition information of the user, and to generate a prompt sentence for instructing a generative AI model to receive the text data as a prompt and to execute processing using the text data; to analyze output data obtained from the generative AI model, to select a recommended point group including at least one mandatory visit point from the candidate point data, and to generate recommendation information by associating priority information and reason information with each point in the recommended point group; to obtain movement time information between the departure point, the recommended point group, and the destination from an external route information providing device, and to execute a route optimization process for calculating time schedule data including a visiting order and an arrival time, a stay time, and a departure time for each point based on the movement time information and the recommendation information; to generate summary text data based on the time schedule data and the recommendation information, to generate a prompt sentence for instructing the generative AI model to receive the summary text data as a prompt and to generate an explanatory text, and to output the generated explanatory text together with the time schedule data to the user device; to analyze at least one of facial expression information, voice information, and biological information acquired from the user device or from a sensor device, and to specify emotion information indicating an emotion state of the user; to associate the emotion information with the candidate point data and the time schedule data, and to dynamically regenerate the time schedule data by changing at least one of the selection of the recommended point group, the stay time, the visiting order, and whether a point is visited, based on the emotion information; and to generate text data including the regenerated time schedule data and change reason information, to generate a prompt sentence for instructing the generative AI model to receive the text data as a prompt and to generate an explanatory text indicating adjustment contents based on the emotion information, and to output the generated explanatory text together with the regenerated time schedule data to the user device. This enables the computer system to internally transform heterogeneous inputs, including free-form user instructions and real-time sensor-based emotion data, into structured route and schedule representations, to employ a generative AI model under explicit prompt control as an active component of route selection and schedule regeneration, and to coordinate external map and route information services in a unified optimization pipeline, thereby improving computational efficiency, adaptability of the scheduling engine, and responsiveness of the overall system to changing user states without requiring manual reconfiguration of the software.

The term “user device” refers to an information processing terminal operated by a user, such as a mobile communication terminal, a portable information terminal, or a personal computer, that is capable of transmitting input information to a server and receiving output information from the server.

The term “sensor device” refers to a hardware device including at least one sensor, such as an image sensor, an audio sensor, or a biological signal sensor, that acquires physical signals related to a user and outputs corresponding digital data to the server or the user device.

The term “departure point” refers to a geographic location that serves as a starting position for movement or travel and that is specified by the user as an origin of a route.

The term “destination” refers to a geographic location that serves as an end position for movement or travel and that is specified by the user as a final target point of a route.

The term “position coordinates” refers to numerical values representing a location in a coordinate system, such as latitude and longitude values in a geographic coordinate system, that identify the position of a departure point, a destination, or a point.

The term “map information storage unit” refers to a storage apparatus or storage area that stores geographic information data, such as road network data, link and node data, and position data of locations, used for route search processing.

The term “point information storage unit” refers to a storage apparatus or storage area that stores point information including at least location data and attribute data for a plurality of points, such as sightseeing points, dining points, or other visitable points along or near a route.

The term “user history information storage unit” refers to a storage apparatus or storage area that stores information related to past behavior of a user, such as previously visited points, selected plans, or evaluation results, to be used for inferring user preferences.

The term “user attribute information storage unit” refers to a storage apparatus or storage area that stores information related to attributes of a user, such as age group, general interests, or preferred categories, to be used for determining preference information and constraint condition information.

The term “preference information” refers to information representing tendencies or likes of a user, including, for example, preferred categories of points, preferred activity types, or qualitative preferences such as “relaxing,” “active,” or “cultural.”

The term “constraint condition information” refers to information representing conditions or limitations applicable to a travel or movement plan, including, for example, a total time budget, desired time windows, mandatory visit requirements, or maximum number of points.

The term “candidate point” refers to a point selected from among a plurality of stored points as being located within a predetermined range of a basic route and being considered as a potential visit point in a plan.

The term “candidate point data” refers to structured data representing one or more candidate points, including at least location data, attribute data such as category or typical stay time, and preference information or constraint condition information associated with the candidate points.

The term “recommended point group” refers to a subset of candidate points selected as recommended visit points by processing that includes analysis of output data from a generative AI model, and that includes at least one mandatory visit point.

The term “recommendation information” refers to information generated for points belonging to the recommended point group, the information including at least priority information and reason information associated with each recommended point.

The term “priority information” refers to information indicating the relative importance, rank, or selection order of a recommended point among a plurality of recommended points.

The term “reason information” refers to explanation information indicating a reason or basis for selection of a recommended point, such as consistency with user preferences or suitability under constraint condition information.

The term “basic route information” refers to route data representing at least one route between a departure point and a destination, the data including, for example, a sequence of links or waypoints, distances, and estimated travel times.

The term “external route information providing device” refers to an external information processing apparatus or service that provides movement time information, distance information, or route information between a plurality of locations based on geographic data and traffic data.

The term “movement time information” refers to information indicating estimated travel times between two or more locations, such as a departure point, recommended points, and a destination, for at least one movement mode.

The term “route optimization process” refers to a computational process that uses movement time information and other parameters to calculate at least an efficient visiting order of multiple points and to generate time schedule data that satisfies constraint condition information.

The term “time schedule data” refers to structured data representing a travel or visit schedule including at least a visiting order and, for each point, an arrival time, a stay time, and a departure time.

The term “text data” refers to data represented as character strings that can be interpreted as natural language or structured descriptions, including descriptions of points, schedules, or reasons.

The term “summary text data” refers to text data that concisely represents at least part of the time schedule data and the recommendation information for use as input to a generative AI model.

The term “prompt sentence” refers to a text sequence supplied as input to a generative AI model to instruct the generative AI model to perform a specific processing operation using included data.

The term “generative AI model” refers to a machine learning model configured to generate text or other content in response to an input prompt, where the model has been trained using a large amount of training data and can output natural language and structured information based on the prompt.

The term “output data obtained from the generative AI model” refers to data generated by the generative AI model in response to a prompt sentence, including at least natural-language text and optionally machine-readable structured data.

The term “explanatory text” refers to natural-language text generated by the generative AI model or by another text generation component, the text describing at least content of a recommended point group, reasons for selection, or details of a time schedule.

The term “facial expression information” refers to data obtained from an image sensor representing at least a face region of a user and used for determining an emotion state of the user.

The term “voice information” refers to audio data representing speech or sounds uttered by a user, used for determining an emotion state or other state of the user.

The term “biological information” refers to data derived from a biological sensor of a user, such as heart rate, skin temperature, or other physiological parameters, used for estimating an emotion state of the user.

The term “emotion information” refers to information indicating an estimated emotion state of a user, such as joy, stress, fatigue, or relaxation, derived from analysis of facial expression information, voice information, or biological information.

The term “change reason information” refers to information indicating at least a cause or basis for modification of time schedule data, the information including, for example, an emotion state of the user and content of corresponding adjustments.

The term “machine-readable travel plan data” refers to data describing a travel plan in a format directly usable by a control device of a moving body, including at least a plurality of route segments and associated timing information.

The term “moving body control device” refers to a control apparatus that controls movement of a moving body, such as a vehicle control system, based on machine-readable travel plan data received from the server.

In one embodiment, a server, a user device, and optional sensor devices cooperate to implement the claimed system. The server comprises at least one processor, a main memory, a non-volatile storage device, and a network interface, and is implemented, for example, as a virtual machine on a cloud computing platform. The server executes an operating system such as a general-purpose server operating system and multiple application modules written in a high-level programming language. The user device is implemented, for example, as a smartphone, tablet, in-vehicle infotainment terminal, or personal computer, and includes a display, input devices, a communication unit, and optionally a camera, a microphone, or interfaces to wearable sensors. A sensor device is implemented, for example, as a smartwatch or other wearable device that measures biological signals.

The server stores a plurality of software modules in the non-volatile storage device. These modules include at least: a user interface generation module, a map access module, a point information management module, a user profile management module, a generative AI interface module, a recommendation analysis module, a route optimization module, an emotion recognition interface module, an emotion-aware schedule regeneration module, and a moving body control interface module. The server also stores a map information storage area, a point information storage area, a user history information storage area, a user attribute information storage area, and an optional emotion history storage area in a database system, for example a relational database management system or a document-oriented database.

The server stores geographic information data in the map information storage area. This data includes node records and link records forming a road network graph, each link having attributes such as length, road class, allowed directions, and nominal speed. The server stores point information in the point information storage area. Each point record contains at least an identifier, a coordinate pair, category codes, tags, typical stay duration, opening hours, and optional ratings. The server stores user history information and user attribute information in their respective storage areas. The user history information includes past routes taken, points visited, user feedback scores, and previous schedule selections, which the server aggregates into feature vectors describing user tendencies. The user attribute information includes demographic attributes and preference labels.

The server stores, in addition, parameterized models for emotion recognition and a generative AI model interface. In one example, the server uses a deep neural network for emotion recognition, implemented using a neural network framework. The emotion recognition model for facial expressions is configured as a convolutional neural network having several convolutional layers with rectified linear unit activation, pooling layers, and fully connected layers that output class probabilities over emotion labels such as joy, stress, fatigue, and neutrality. For voice-based emotion recognition, the server uses a recurrent network or a transformer encoder that receives acoustic feature sequences such as Mel-frequency cepstral coefficients. The server trains these models prior to deployment using supervised learning. During training, the server uses a cross-entropy loss function between predicted emotion probabilities and ground truth labels, and updates weights by stochastic gradient descent or a variant with momentum and adaptive learning rates. The training data comprises labeled images and audio segments collected from multiple users, and the server may augment the training data by random cropping, rotation, and noise addition to improve robustness.

The server does not host the generative AI model itself in some embodiments, but instead communicates with an external generative AI model service through a network interface. The generative AI model is, for example, a transformer-based language model trained on large corpora of text. The server treats the generative AI model as a deterministic function from an input character sequence to an output sequence under fixed parameters. The server does not rely on unspecified reasoning by the model, but instead constructs precise prompt sentences with explicit instructions and structured context so that the model's behavior is constrained to generating ranked lists, explanations, or structured text that can be parsed.

The server generates prompt sentences according to rule-based templates. The server selects appropriate templates based on an internal state and inserts variable fields such as candidate point names, categories, time budgets, and user preferences. By designing prompts in this rule-driven, template-based manner, the server constrains the generative AI model outputs to formats that can be parsed by deterministic text parsers. This reduces parsing errors and improves computational efficiency relative to naive free-form model interactions.

The user operates the user device to start a travel planning application. The terminal displays an initial screen generated by the server through the user interface generation module. The user inputs a departure point and a destination in a text field, or selects these locations on an interactive map. The user may add natural-language instructions such as “I want to relax and enjoy local food” or “Include at least one famous temple.” The terminal transmits the input information to the server as structured messages.

The server receives the input information and uses the map access module to convert textual place names into position coordinates by querying the map information storage area or an external geocoding service. The server then constructs a route search query using those coordinates and instructs an external route information providing device to compute a shortest-time or constraint-aware route using algorithms such as Dijkstra or A* applied to a road graph. The external device returns a sequence of links and associated travel times. The server stores this as basic route information. This offloads low-level routing computation to a specialized service while allowing the server to integrate the result with higher-level scheduling logic.

The server uses the point information management module to identify candidate points. The server computes, for each point in the point information storage area, the minimum distance to any edge in the polyline representing the basic route. For efficiency, the server uses spatial indexing structures such as R-trees or grid indexing so that distance calculations are performed only for points likely to be near the route. The server selects points whose distance is under a threshold and whose category is compatible with an active profile, thereby generating candidate point data. The server attaches typical stay duration and time windows to each candidate.

The server uses the user profile management module to derive preference information and constraint condition information. The server represents each point by a feature vector including category codes, tags, and inferred properties. The server also represents the user's history by a feature vector computed as a weighted average of feature vectors of previously visited points, with weights derived from feedback scores and recency. The server computes similarity scores between candidate point feature vectors and the user history vector using metrics such as cosine similarity. The server interprets higher similarity scores as stronger preference signals and includes them as numerical preference features in the candidate point data. The server also collects constraint condition information, such as the total time window from departure to arrival, maximum number of stops, and mandatory visit flags for certain cities.

The server uses the generative AI interface module to construct a prompt sentence that includes structured descriptions of the candidate points and user context. In one example, the server builds the following prompt sentence:
“Departure: Tokyo.
Destination: Osaka.
Time budget for the whole trip: 10 hours.
User preferences: relaxing places, traditional culture, local food.
Candidate spots along the route (each format: [ID] name-category, stay time):
[1] Nagoya eel restaurant-local specialty, stay 90 minutes.
[2] Kyoto Kiyomizu-dera-historical temple, stay 120 minutes.
[3] Lake resort-relaxing nature, stay 60 minutes.

Select 2 or 3 spots that best match the user preferences and time budget.

Output a ranked list with IDs and a brief reason for each choice.”

The server transmits the prompt sentence to the generative AI model service and receives an output string. The recommendation analysis module parses the output using regular expressions or simple parsing logic to extract selected identifiers and associated reasons. For example, the generative AI model may output:

“Recommended spots:
1) [2] Kyoto Kiyomizu-dera-fits traditional culture and can be visited within the time budget.
2) [1] Nagoya eel restaurant-offers local food and a relaxing lunch break.”

The server maps these identifiers back to candidate point records and constructs recommendation information that includes priority information (such as rank or score) and the extracted reason information. By restricting the output format through template-based prompts, the server reduces the parsing complexity and error rate, which directly improves the speed and accuracy of downstream computations.

The server uses the route optimization module to compute an optimized visit order and time schedule data. The server forms a list of points including the departure point, all recommended points, and the destination. For each ordered pair of points, the server queries the external route information providing device for estimated movement time and distance, caching results for reuse. The server constructs a travel time matrix. The route optimization module then executes a heuristic algorithm for the traveling-salesman-type problem that respects time windows and stay durations. For example, the server uses a greedy insertion heuristic followed by local search operations such as 2-opt or 3-opt to minimize the total travel time while ensuring that the user arrives at the destination within the time budget. The server generates time schedule data including, for each point, an arrival time, a stay time, and a departure time, and stores the data in a table structure in memory.

The server uses the generative AI interface module again to transform the schedule into an explanatory text for the user. The server constructs a second prompt sentence such as:
“Create a concise English explanation of the following travel schedule:
09:00 depart from Tokyo by car.
12:00-13:30 lunch at a famous eel restaurant in Nagoya (local specialty).
15:30-17:30 sightseeing at Kiyomizu-dera temple in Kyoto (historic temple).
19:30 arrive in Osaka.

The user prefers relaxing places and traditional culture.

Explain why these stops were chosen and how the schedule fits in the 10-hour time budget.”

The server receives the explanatory text from the generative AI model and forwards both time schedule data and the explanation to the user device. The terminal presents a timeline view, a list of recommended spots, and the explanatory text to the user. The terminal may display the route and spots on an embedded map component.

In another embodiment, the server also processes real-time user emotion information. The user carries a user device and optionally wears a sensor device. The terminal acquires facial expression information using a built-in camera and compresses the image into a lower-resolution grayscale representation. The terminal computes facial landmarks and extracts regions of interest. The server or the terminal passes these to the emotion recognition neural network, which produces a probability distribution over emotion classes. The server or the terminal chooses the class with the highest probability above a threshold as the emotion label. For voice information, the terminal captures short audio segments, computes acoustic features, and sends these features to the server. The server processes the features with an emotion recognition model trained in a similar manner and generates an emotion label.

The server stores timestamped emotion information in the emotion history storage area. The emotion-aware schedule regeneration module reads the latest emotion label and applies non-conventional rules that are not simply reproductions of human manual editing. For example, the server uses a rule set such as: if the emotion label indicates fatigue and the predicted walking distance in the next segment exceeds a threshold, the server automatically searches the point information storage area for alternative points with shorter walking distances and relaxing categories, and proposes replacements. The server modifies the time schedule data accordingly. By embedding these algorithmic rules, the server performs automated decision-making that goes beyond merely following user commands and achieves a computational optimization of the schedule in response to sensor-derived signals.

The server then constructs another prompt sentence to explain changes to the user. An example prompt sentence is:
“Current plan: Tokyo→Nagoya eel lunch→Kyoto Kiyomizu-dera→Osaka.
Detected user emotion: fatigue (high confidence).

To reduce walking and add relaxation, the system replaced part of the Kyoto walking tour with a hot-spring visit near Kyoto and extended the rest time in Nagoya.

Write a short explanation to the user describing what changed and why the plan is now more suitable for a tired traveler.”

By using sensor-based emotion information and rules for schedule regeneration, the server continuously adapts the plan and produces updated explanations, thereby improving the responsiveness of the system to user state. This is not a simple automation of human planning, because the system uses real-time physiological features and machine-trained classifiers to trigger non-obvious schedule modifications driven by computational optimization and pre-defined rules.

In another embodiment, the server also supports interpretation of free-form travel requests. The user may enter on the user device a sentence such as “I want to visit points A, B, and C today and get back home as quickly as possible.” The terminal transmits this string to the server. The server constructs a prompt sentence for the generative AI model such as: “User input: ‘I want to visit points A, B, and C today and get back home as quickly as possible.’

Extract the following fields and output them in a clear text format:
(1) departure point,
(2) list of visit points,
(3) desired return condition,
(4) any time constraints mentioned.”

The server parses the model's response and converts it into structured data. The server then uses the same route optimization and scheduling modules. This improves the computer's ability to convert unstructured text into usable internal representations without requiring complex hand-crafted natural language parsers. The internal behavior of the generative AI model is controlled through prompts and post-processing logic so that the server can guarantee a consistent interface.

In yet another embodiment, the server communicates with a moving body control device. The server converts time schedule data and recommendation information into machine-readable travel plan data describing individual route segments and planned stop durations. The server transmits this data to the moving body control device, which controls an autonomous vehicle to travel along the planned route and to stop at recommended points. The in-vehicle user device displays updated plans and explanatory texts, and the emotion recognition subsystem may use in-cabin cameras and microphones to track user state during movement. When the server detects a significant change in emotion or when traffic conditions change, the server recomputes a revised schedule and transmits updated plan data to the moving body control device. This integration demonstrates that the claimed invention is tightly coupled to physical control of movement in the real world, rather than being limited to abstract planning.

The described architecture improves computer technology in multiple ways. By representing candidate points, user preferences, emotion information, and schedule elements as structured data, and by orchestrating external route services and generative AI models via carefully designed prompt sentences, the server reduces redundant computation, limits external service calls, and performs route optimization on reduced candidate sets. The use of spatial indexing for point selection, similarity-based preference scoring, and heuristic route optimization yields faster schedule computation compared to naive exhaustive search. The constrained use of generative AI outputs through templates reduces parsing errors, thereby improving the accuracy and stability of the system.

Moreover, the combination of emotion recognition modules and rule-based schedule regeneration allows the server to proactively adjust plans without manual user input, reducing the need for repeated user interactions and network exchanges. This lowers communication overhead and reduces processing load on the user device. The learnable components (emotion recognition neural networks) use specific feature extraction methods, loss functions, and optimization procedures, and the server integrates their outputs into deterministic optimization pipelines. This results in improved prediction accuracy for user state, which, in turn, leads to more appropriate and efficient schedule modifications.

Alternative embodiments may use different neural network architectures for emotion recognition, such as residual networks or graph neural networks for multi-modal fusion of facial and physiological signals. Alternative route optimization algorithms, such as mixed-integer programming solvers or metaheuristics, may also be used. The generative AI model could be self-hosted or replaced by another sequence model as long as the server generates prompt sentences and parses the resulting output in the described manner. The modular configuration allows partial replacement of components while preserving the overall data flow: the server always converts heterogeneous inputs into structured internal representations, uses these representations to compute optimized time schedules, and outputs both machine-readable plan data and human-readable explanations.

Through these detailed configurations and interactions, the server, the user device, and the sensor devices implement the claimed system in a way that improves the functioning of the computer itself, enhances computational efficiency and accuracy of route and schedule planning, and enables real-time control of movement and user interfaces that responds to both explicit user requests and implicit emotion states.

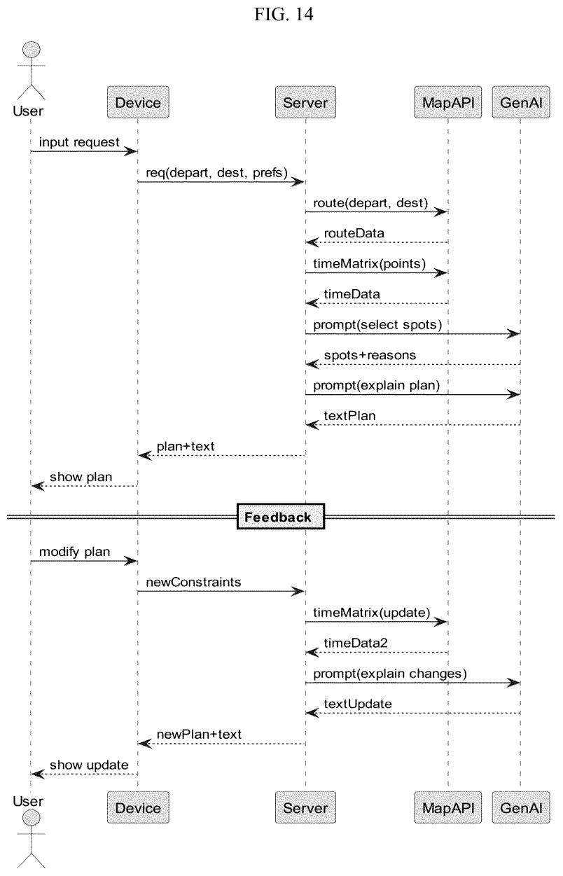

The following describes the processing flow using FIG. 14.

### Step 1:

User operates the terminal to start a travel planning application and to input initial information.

Input: free-form text such as “Tokyo to Osaka, I want to relax and eat local food,” and/or map selections for a departure point and a destination.

Output: a structured message containing a departure place name or coordinates, a destination place name or coordinates, and free-form preference text.

User enters the departure point and the destination into text fields or taps them on a map widget. User optionally enters additional constraints such as a desired arrival time or a maximum total travel time. Terminal converts the user actions into a structured data object including location identifiers and raw preference text, and transmits this object to the server via a network connection.

### Step 2:

Server normalizes locations and obtains basic route information.

Input: structured message with departure and destination identifiers and optional coordinates.

Output: basic route information including a sequence of waypoints, distances, and estimated travel times between the departure point and the destination.

Server uses a map access module to resolve place names into position coordinates by querying a map information storage unit or an external geocoding service. Server then generates a route search request using these coordinates and sends the request to an external route information providing device. The external device executes a route search algorithm such as Dijkstra or A* on a road network graph and returns a polyline route with associated segment times. Server parses the response, constructs a list of segments with coordinates and travel times, and stores this as basic route information for later use.

### Step 3:

Server extracts candidate points along or near the basic route.

Input: basic route information and point records from a point information storage unit.

Output: candidate point data including identifiers, coordinates, categories, tags, typical stay durations, and distance to the route.

Server retrieves all point records from the point information storage unit or from a spatial index that intersects the bounding region of the route. Server calculates, for each point, the minimum distance from the point coordinate to any segment of the route polyline using geometric distance formulas. Server filters points whose distance is below a predefined threshold and whose categories match a set of allowed categories. Server creates candidate point data records that include the original attributes plus computed distance and stores them in memory as a candidate list.

### Step 4:

Server derives user preference information and constraint condition information.

Input: user identifier, user history information, user attribute information, and free-form preference text from Step 1.

Output: numerical preference scores for each candidate point and a set of constraint parameters such as time budget, maximum number of stops, and mandatory points. Server looks up user history records, including previously visited points and past ratings, from a user history information storage unit. Server represents each point as a feature vector (for example, category one-hot encoding, tag embeddings, and typical price range) and computes a user preference vector as a weighted average of feature vectors of highly rated points, weighting by recency and rating score. Server then computes, for each candidate point, a similarity between its feature vector and the user preference vector using a similarity function such as cosine similarity, producing a scalar preference score. Server also parses the free-form preference text using a small classifier or keyword rules to infer qualitative preferences (for example, “relaxing,” “local food,” “temple”). Server maps these qualitative preferences to category weights and further adjusts the preference scores. In parallel, server derives constraint parameters from the input, such as departure time, required arrival time, and maximum allowed number of stops, and stores them as constraint condition information.

### Step 5:

Server compiles candidate point data and user context and constructs a first prompt sentence for a generative AI model.

Input: candidate point data with preference scores, departure and destination names, and constraint condition information.

Output: a prompt sentence in natural language that instructs the generative AI model to select optimal recommended points.

Server selects a subset of top-ranked candidate points based on preference scores and distance to the route to limit prompt length. Server converts each selected candidate into a concise textual description such as “[ID] name-category, stay XX minutes, preference score YY.” Server then inserts these descriptions, along with the departure, destination, user preferences, and time budget, into a prompt template. For example, server constructs a prompt sentence:

“Departure: Tokyo. Destination: Osaka. Time budget: 10 hours. User prefers relaxing places and local food. Candidate spots along the route: [1] Nagoya eel restaurant-local specialty, stay 90 minutes. [2] Kyoto Kiyomizu-dera-historical temple, stay 120 minutes. Select 2 or 3 spots that best match the preferences and time budget, and output a ranked list with IDs and reasons.”

Server sends this prompt sentence to the generative AI model service via a network API.

### Step 6:

Server analyzes output from the generative AI model and generates recommendation information.

Input: prompt sentence and output text from the generative AI model.

Output: recommendation information including a recommended point group with priority information and reason information for each recommended point.

Server receives the generative AI model output, which typically contains a ranked list of candidate identifiers and corresponding reasons. Server applies a deterministic parser to identify point IDs, rank positions, and textual explanations. Server cross-references the extracted IDs with candidate point data to ensure they exist and removes any invalid references. Server assigns a priority value to each recommended point according to the order given by the model and stores the model's textual reasons as reason information. Server packs this into recommendation information records that link each recommended point ID to its priority, reason, and original attributes.

### Step 7:

Server obtains movement time information between all relevant locations.

Input: list of locations including the departure point, the destination, and all recommended points, and road network data accessible through the external route information providing device.

Output: a movement time matrix specifying estimated travel times and distances between each pair of locations.

Server generates a set of ordered location pairs (origin, destination) covering all combinations needed for scheduling. Server sends batched queries to the external route information providing device, requesting estimated travel times and distances for each pair. Server caches responses so that repeated queries for the same pair are avoided. Server aggregates the returned times and distances into a matrix or table structure in memory, where each cell contains travel time, distance, and possibly additional information such as tolls. This matrix becomes the input for route optimization.

### Step 8:

Server executes a route optimization process to create time schedule data.

Input: movement time matrix from Step 7, recommendation information from Step 6, and constraint condition information from Step 4.

Output: time schedule data including a visiting order and, for each point, an arrival time, a stay time, and a departure time.

Server initializes an initial visiting order, for example by sorting recommended points according to their positions along the basic route or by a nearest-neighbor heuristic using the movement time matrix. Server then applies an improvement algorithm such as a 2-opt or insertion heuristic that iteratively swaps or inserts points to reduce total travel time while respecting constraints on total duration and mandatory arrival times. For each candidate order, server computes cumulative travel time plus stay times and checks whether constraints are satisfied. Once an acceptable or near-optimal order is found, server assigns specific arrival and departure times, starting from the user's departure time. Server constructs time schedule data as a table in which each row corresponds to a point and contains columns for point ID, scheduled arrival time, scheduled stay duration, and scheduled departure time.

### Step 9:

Server generates a second prompt sentence to obtain an explanatory text for the time schedule.

Input: time schedule data and recommendation information.

Output: a prompt sentence instructing the generative AI model to produce human-readable explanatory text, and the explanatory text returned by the model.

Server converts each scheduled stop into a short line of text such as “09:00-10:30: visit Nagoya eel restaurant for lunch (local specialty).” Server composes these lines into a schedule description and adds context about user preferences and time budget. For example, server builds a prompt sentence:

“Create a clear explanation of the following schedule: 09:00 depart Tokyo; 12:00-13:30 lunch at a famous eel restaurant in Nagoya; 15:30-17:30 sightseeing at Kiyomizu-dera temple in Kyoto; 19:30 arrive in Osaka. The user prefers relaxing places and traditional culture. Explain briefly why these stops were chosen and how the schedule fits within 10 hours.”

Server sends this prompt sentence to the generative AI model and receives an explanatory text. Server pairs this text with the original time schedule data for transmission to the terminal.

### Step 10:

Terminal presents the schedule and explanation and collects feedback from the user.

Input: time schedule data and explanatory text sent by the server.

Output: user feedback or modification requests such as changed stay times, added or removed points, or updated constraints.

Terminal renders the time schedule on a graphical timeline and displays the explanatory text.

Terminal overlays the route and recommended points on a map, allowing the user to inspect details by tapping on markers. User may adjust the plan by dragging time blocks, toggling checkboxes for points to include or exclude, or entering comments such as “shorten Kyoto stay” or “add a hot spring near Kyoto.” Terminal collects these modifications into a structured object containing new constraints (for example, updated stay durations or a changed list of required points) and sends them to the server for re-optimization.

### Step 11:

Server processes user modifications and recalculates an updated time schedule.

Input: original time schedule data, recommendation information, and user modification data from Step 10.

Output: an updated time schedule and, optionally, updated recommendation information and explanatory text.

Server reads the user modification data and adjusts constraint condition information and candidate point sets accordingly. For example, server removes points the user has deselected, adjusts stay durations based on user input, or adds new candidate points if the user has requested additional categories. Server reruns the route optimization process using the updated constraints and movement time matrix, producing a new time schedule. Server optionally constructs a new prompt sentence summarizing the changes and asks the generative AI model to explain what has changed and why. Server then sends the updated schedule and explanation back to the terminal.

### Step 12:

Terminal and sensor devices acquire emotion-related data and send it to the server.

Input: raw sensor data including facial images, voice recordings, and biological signals such as heart rate and skin temperature.

Output: emotion data or preprocessed features suitable for emotion classification by the server.

Terminal activates a camera to periodically capture facial images of the user, and activates a microphone to record short segments of the user's voice. Terminal also reads physiological values from a connected sensor device such as a smartwatch. Terminal optionally compresses and normalizes these data streams, for example by computing grayscale, resizing images, or extracting acoustic features. Terminal sends the preprocessed data or full raw data to the server for emotion analysis.

### Step 13:

Server analyzes emotion information and updates emotion labels.

Input: image and audio features and biological signal values from Step 12.

Output: an emotion label such as joy, stress, fatigue, or neutral, optionally with a confidence score.

Server feeds facial image data through a convolutional neural network configured for emotion classification. Server calculates an output probability distribution over emotion classes, applies a softmax function, and selects the class with the highest probability exceeding a threshold. For audio features, server processes the feature sequence with a recurrent or transformer-based network trained to classify emotion from speech. For biological signals, server computes summary statistics such as average and variance and feeds them into a smaller classifier. Server may fuse these outputs by weighted averaging or decision rules to obtain a final emotion label and confidence. Server stores timestamped emotion labels in an emotion history storage unit.

### Step 14:

Server regenerates time schedule data based on detected emotion.

Input: current time schedule data, recommendation information, and latest emotion label from Step 13.

Output: regenerated time schedule data that reflects emotion-aware adjustments.

Server applies predefined rules that map emotion labels to schedule adjustments. For example, if the emotion label is fatigue and the next scheduled segment has a long walk or dense activities, server searches for alternative points with relaxing categories and shorter walking requirements from the point information storage unit. Server temporarily inserts or replaces points and recomputes arrival and departure times using the movement time matrix.

Server ensures that the updated schedule still satisfies global constraints such as final arrival time. Server produces a regenerated time schedule that includes new or adjusted stops and modified stay durations.

### Step 15:

Server constructs an emotion-aware prompt sentence and obtains an explanatory text for the regenerated schedule.

Input: regenerated time schedule data, the previous schedule data, recommendation information, and the current emotion label.

Output: an explanatory text describing emotion-based adjustments.

Server builds a prompt sentence that explicitly states the original plan, the detected emotion, and the planned modifications. For example, server constructs:

“Original plan: Tokyo→Nagoya eel lunch→Kyoto Kiyomizu-dera→Osaka. Detected emotion: fatigue. The system added a hot-spring stop near Kyoto and shortened walking at the temple. Write a short message to the user explaining what changed and why this is better for a tired traveler.”

Server sends this prompt sentence to the generative AI model and receives a short explanatory text. Server transmits this text along with the regenerated schedule data to the terminal.

### Step 16:

Terminal displays the emotion-aware updated plan to the user.

Input: regenerated time schedule data and emotion-aware explanatory text.

Output: user acknowledgment or further adjustments.

Terminal updates the time schedule view, highlighting added, removed, or adjusted stops.

Terminal displays the emotion-aware explanation so that the user understands why the plan has changed. User may accept the changes or further customize the plan, in which case the loop of modification and optimization can continue.

### Step 17:

Server generates machine-readable travel plan data for a moving body control device.

Input: final time schedule data and route segment information associated with each scheduled movement.

Output: machine-readable travel plan data containing a sequence of route segments, waypoints, and target times.

Server maps each scheduled movement between two points to a sequence of waypoints obtained from the external route information providing device. Server packages these waypoints, with associated target arrival times and stop durations, into a data structure conforming to the interface specification of a moving body control device. Server sends this travel plan data to the control device via a communication channel, thereby enabling automatic navigation according to the optimized and emotion-aware schedule.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

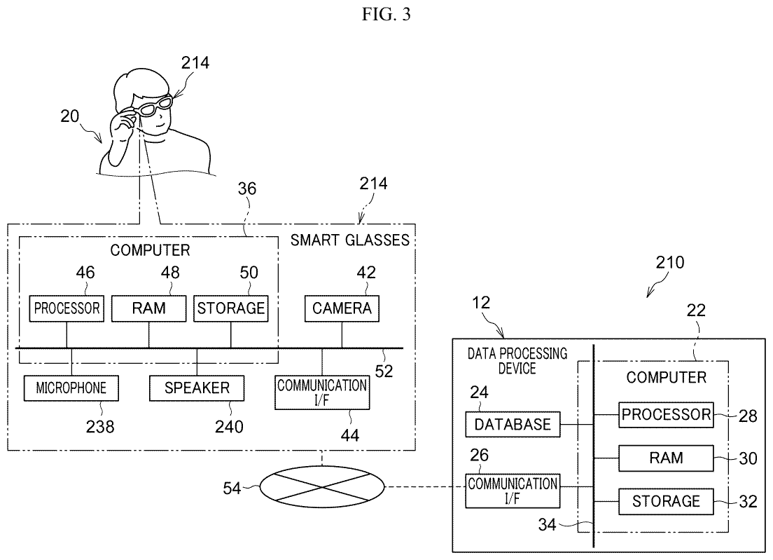

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

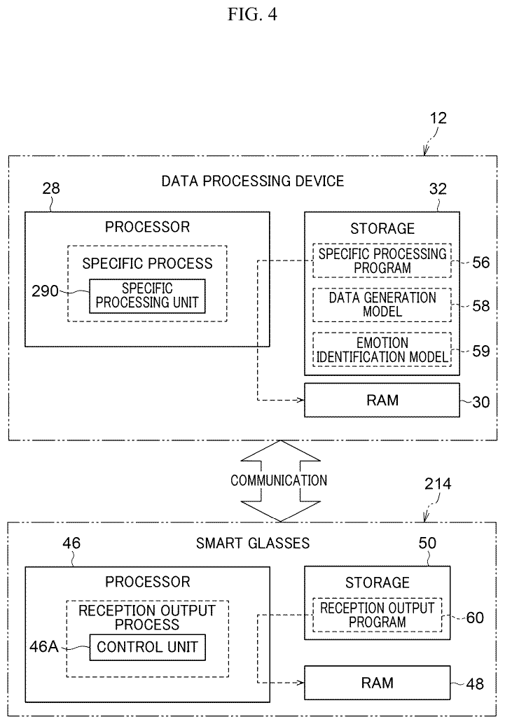

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

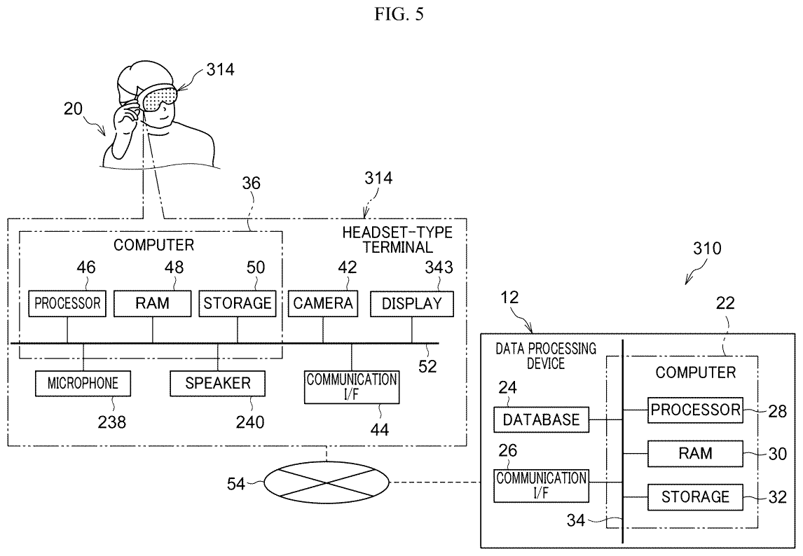

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

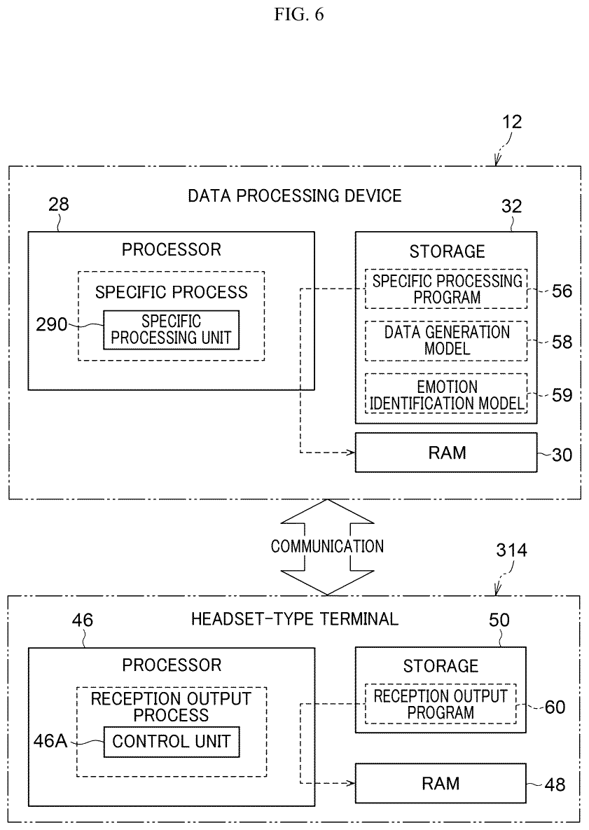

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

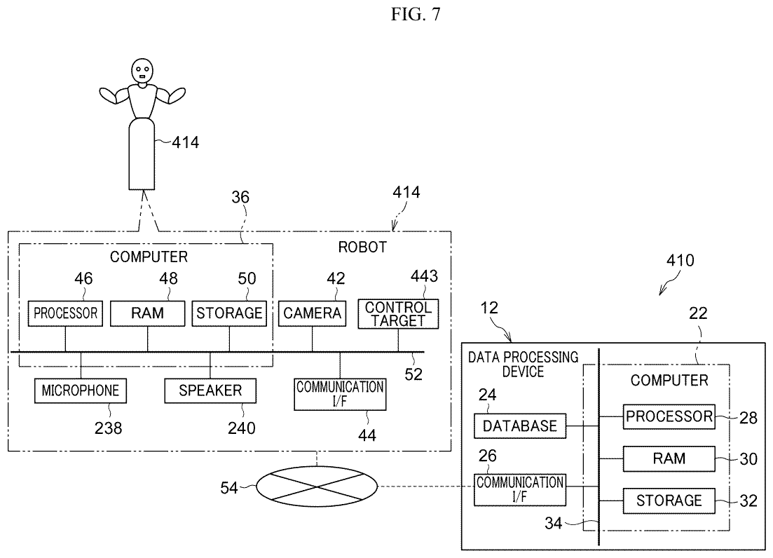

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

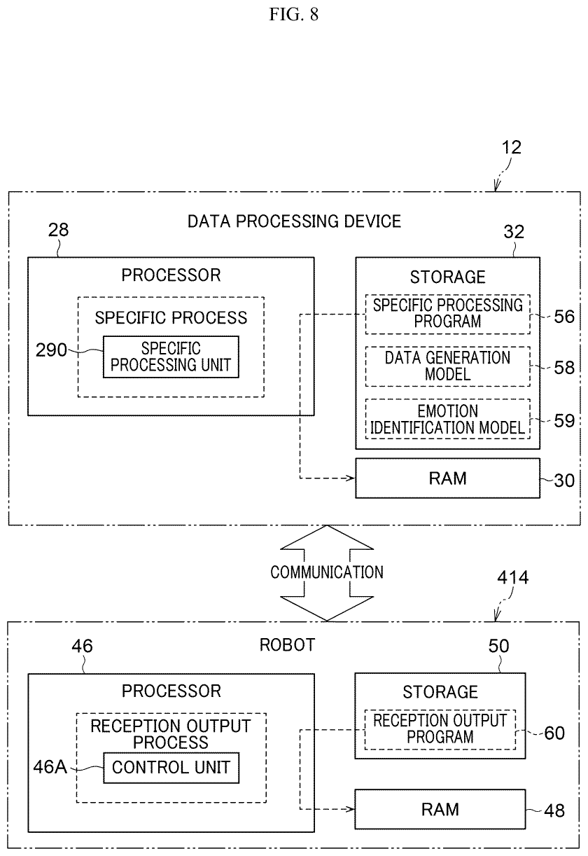

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

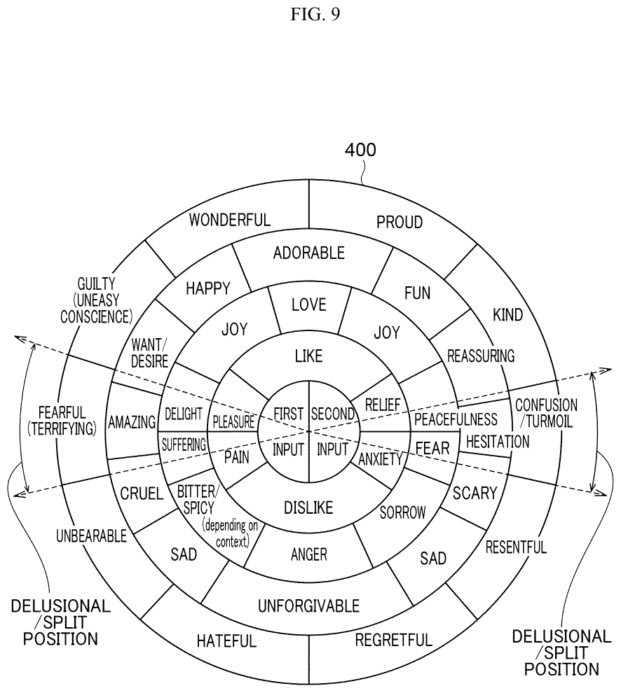

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

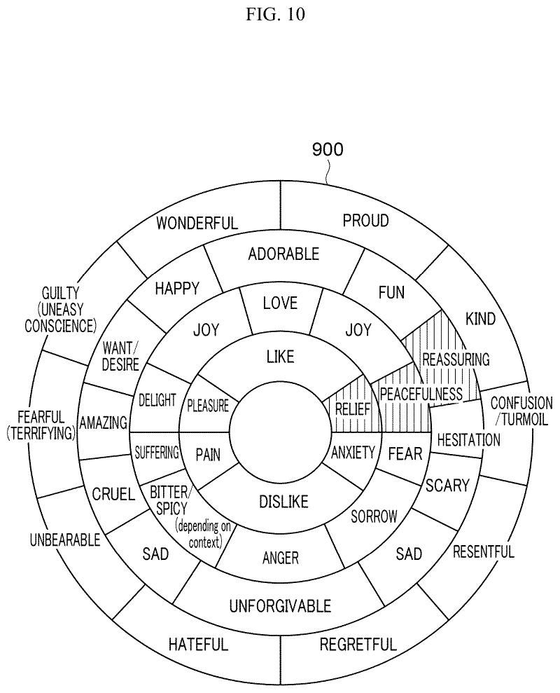

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
provide, to a terminal device, an information input/output screen for receiving location information as a movement start position and a movement end position from a user,
receive, via a communication network, the location information transmitted from the terminal device, generate structured data including the location information, and transmit route calculation request data including the structured data to an external route information providing apparatus by using a secure communication scheme,
acquire route information relating to a plurality of candidate routes between the movement start position and the movement end position from the external route information providing apparatus, analyze the route information, calculate, for each candidate route, a movement time, a movement distance, and a transportation mode to be used, and identify an optimal movement route from among the candidate routes based on a predetermined selection condition,
classify each movement section included in the identified optimal movement route into at least one of a walking section, a public transportation section, and a vehicle section, and generate proposal information for each movement section, the proposal information including a departure time, an arrival time, a movement time, a movement distance, and the transportation mode to be used,
transmit the proposal information to the terminal device and cause the terminal device to present, on the information input/output screen, the proposal information in a list format arranged in chronological order and as a route display on a map image,
cause the terminal device to present an input field for receiving, from the user, a prompt sentence described in natural language as a generation request for a detailed travel plan based on the proposal information, and acquire the prompt sentence transmitted from the terminal device,
construct input data for a generative artificial intelligence model, the input data including the prompt sentence and the route information relating to the identified optimal movement route, transmit the input data to the generative artificial intelligence model to cause the generative artificial intelligence model to generate travel plan text expressed in natural language, and analyze the generated travel plan text to generate travel plan data including an itinerary overview, a section-by-section itinerary, and recommendations, and
transmit the travel plan data to the terminal device and cause the terminal device to display, on the information input/output screen, the travel plan text in association with the proposal information.

### (Supplementary 2)

The system according to supplementary 1,
wherein the processor is configured to
include, in the route calculation request data, at least one optimization condition relating to at least one of a type of transportation mode, a number of transfers, a movement time, and a movement distance, and update the proposal information so as to satisfy the optimization condition based on the route information acquired from the external route information providing apparatus.

### (Supplementary 3)

The system according to supplementary 1,
wherein the processor is configured to
cause the prompt sentence input to the generative artificial intelligence model to include at least one of a use restriction on a specific transportation mode, a desired condition relating to movement time, a desired condition relating to cost, and a desired condition relating to a point of interest, and add actual movement times and movement distances obtained from the route information to the travel plan text obtained from the generative artificial intelligence model to generate the travel plan data.

### Application Example 1

### (Supplementary 1)

A system comprising a processor and a communication interface,
wherein the processor is configured to
cause an information processing terminal including a display device and an input device to provide a user interface for setting a departure location and a destination location, and to receive departure location data and destination location data from the information processing terminal via the communication interface,
generate, based on the departure location data and the destination location data, a control instruction sentence for route-search processing, and generate a prompt sentence for inputting the control instruction sentence into a generative AI model,
transmit, via the communication interface, the prompt sentence to the generative AI model operating on an external information processing apparatus, and receive, from the generative AI model, route-related information including intermediate location information arranged between the departure location data and the destination location data, movement time information between respective intermediate locations, and stay time information,
acquire position coordinate information for each location name included in the route-related information by referring to a location reference information database, and convert the departure location data, the destination location data, and the intermediate location information into corresponding position coordinate information,
transmit, via the communication interface, route calculation request data to an external map information providing apparatus, the route calculation request data instructing execution of route-calculation processing based on the position coordinate information, and receive, from the external map information providing apparatus, detailed route information including movement distance information and movement required time information for each section, calculate, based on the detailed route information and the stay time information received from the generative AI model, arrival time information and departure time information for each location in consideration of departure time information or arrival time constraint information, and generate time plan information, and
generate route geometry information and location display information based on the position coordinate information and the detailed route information, and transmit the route geometry information, the location display information, and the time plan information to the information processing terminal via the communication interface so as to cause a map display device of the information processing terminal to perform route display and time plan display.

### (Supplementary 2)

The system according to supplementary 1,
wherein the processor is configured to
include, in the prompt sentence to be input to the generative AI model, regional specialty information, sightseeing information, dining information, and user preference conditions, to thereby instruct the generative AI model to output route-related information including stop candidate location information arranged between the departure location data and the destination location data, and to reflect the stop candidate location information in the time plan information.

### (Supplementary 3)

The system according to supplementary 1,
wherein the processor is configured to
receive, from the information processing terminal, update condition information including at least one of stop location type conditions, arrival time conditions, total movement time conditions, and stay time conditions set by a user, generate an update prompt sentence including the update condition information, input the update prompt sentence to the generative AI model to acquire updated route-related information, and regenerate the time plan information and the route display based on the updated route-related information.

### Example 2

### (Supplementary 1)

A system comprising a processor,
wherein the processor is configured to
provide an information input/output interface for setting a departure location and a destination location,
acquire position information corresponding to the departure location and the destination location and generate route information between the departure location and the destination location based on the position information,
identify a route-surrounding region corresponding to the route information and acquire, from a structured information set stored in an external storage device, sightseeing-related information, regional specialty-related information, and dining-related information included in the route-surrounding region,
extract candidate stopover locations by evaluating the sightseeing-related information, the regional specialty-related information, and the dining-related information based on a positional relationship with the route information and on an evaluation index, and present the candidate stopover locations to a user,
receive an operation in which at least a part of the candidate stopover locations is selected by the user as mandatory stopover locations, update the route information based on a selection result, and generate travel plan information including the mandatory stopover locations, generate a prompt sentence for input to a generative AI model based on information relating to the departure location, the destination location, and the candidate stopover locations, input the prompt sentence to the generative AI model, analyze output information obtained from the generative AI model, and correct or extend the candidate stopover locations or the travel plan information with additional information based on the output information, and
output, to the information input/output interface, the travel plan information including a result of the correction or extension by use of the generative AI model.

### (Supplementary 2)

The system according to supplementary 1,
wherein the processor is configured to
include identification information and attribute information of the candidate stopover locations in the prompt sentence, compare location names or region names included in the output information from the generative AI model with the structured information set to specify corresponding location identification information, and update the evaluation index of the candidate stopover locations on the basis of the location identification information.

### (Supplementary 3)

The system according to supplementary 1,
wherein the processor is configured to
recalculate an intermediate route passing through the mandatory stopover locations, generate time schedule information based on estimated travel time information for each section of the intermediate route and estimated stay time information for each mandatory stopover location, generate a prompt sentence including the time schedule information and attribute information relating to the mandatory stopover locations, input the prompt sentence to the generative AI model, acquire itinerary description information in natural language from the generative AI model, and associate the itinerary description information with the time schedule information and output the itinerary description information.

### Application Example 2

### (Supplementary 1)

A system comprising a processor,
wherein the processor is configured to
acquire input information including a departure point and a destination from a user device, and generate a user interface for setting the departure point and the destination based on the input information,
obtain position coordinates corresponding to the departure point and the destination, refer to a map information storage unit storing geographic information data, generate an instruction text for causing an external route search process to be executed, and obtain basic route
information from the departure point to the destination by causing the external route search process to be executed based on the instruction text,
refer to a point information storage unit storing point information including sightseeing point information and dining point information, and extract candidate points existing within a predetermined range of the basic route based on the basic route information and the point information,
refer to a user history information storage unit and a user attribute information storage unit, acquire preference information and constraint condition information of a user, and generate candidate point data by adding the preference information and the constraint condition information to the candidate points,
generate text data including the candidate point data, the departure point, the destination, and the preference information and the constraint condition information of the user, and generate a prompt sentence for instructing a generative AI model to receive the text data as a prompt and to execute processing using the text data,
analyze output data obtained from the generative AI model, select a recommended point group including at least one mandatory visit point from the candidate point data, and generate recommendation information by associating priority information and reason information with each point in the recommended point group,
obtain movement time information between the departure point, the recommended point group, and the destination from an external route information providing device, and execute a route optimization process for calculating time schedule data including a visiting order and an arrival time, a stay time, and a departure time for each point based on the movement time information and the recommendation information,
generate summary text data based on the time schedule data and the recommendation information, generate a prompt sentence for instructing the generative AI model to receive the summary text data as a prompt and to generate an explanatory text, and output the generated explanatory text together with the time schedule data to the user device,
analyze at least one of facial expression information, voice information, and biological information acquired from the user device or from a sensor device, and specify emotion information indicating an emotion state of the user,
associate the emotion information with the candidate point data and the time schedule data, and dynamically regenerate the time schedule data by changing at least one of the selection of the recommended point group, the stay time, the visiting order, and whether a point is visited, based on the emotion information, and
generate text data including the regenerated time schedule data and change reason information, generate a prompt sentence for instructing the generative AI model to receive the text data as a prompt and to generate an explanatory text indicating adjustment contents based on the emotion information, and output the generated explanatory text together with the regenerated time schedule data to the user device.

### (Supplementary 2)

The system according to supplementary 1,
wherein the processor is configured to generate a prompt sentence for instructing the generative AI model to receive free-form character string data acquired from the user device as a prompt and to convert the free-form character string data into structured data including departure point information, destination information, desired visit point information, and time constraint information, and to use the structured data as input to a reference process for the map information storage unit and to the route optimization process.

### (Supplementary 3)

The system according to supplementary 1,
wherein the processor is configured to communicate with a mobile body control device, generate machine-readable travel plan data including a plurality of route segments from the departure point to the recommended point group and the destination based on the time schedule data and the recommendation information, and provide the travel plan data to the mobile body control device so as to cause automatic movement control.

What is claimed is:

1. A system comprising:
circuitry configured to:
receive, via a communication interface coupled to a packet-switched network, from a terminal device, first input data and second input data each representing a respective location parameter;
generate, based on the first input data and the second input data, structured instruction data for an external information processing apparatus, the structured instruction data specifying a computation to be performed by the external information processing apparatus using the first input data and the second input data as constraint parameters;
transmit, via the communication interface, the structured instruction data to the external information processing apparatus and receive, from the external information processing apparatus, result data representing a plurality of candidate data records each associated with the first input data and the second input data;
analyze the result data to select, from the plurality of candidate data records, a selected data record based on a predetermined selection condition;
generate a prompt sentence for instructing a generative neural network model to generate output data based on the selected data record; and
transmit, via the communication interface, the output data to the terminal device.

2. The system according to claim 1, wherein the circuitry is further configured to:
generate second structured instruction data for a second external information processing apparatus based on the selected data record; and
transmit, via the communication interface, the second structured instruction data to the second external information processing apparatus and receive, from the second external information processing apparatus, supplementary data associated with the selected data record.

3. The system according to claim 2, wherein the circuitry is further configured to:
segment the selected data record into a plurality of section data records, each section data record representing a respective portion of the selected data record; and
associate, with each section data record, a respective classification label selected from a predetermined set of classification labels.

4. The system according to claim 3, wherein the circuitry is further configured to:
generate, for each section data record, proposal data comprising a first time parameter, a second time parameter, a duration parameter, a distance parameter, and a mode classification label; and
transmit the proposal data to the terminal device to cause the terminal device to render the proposal data in a chronologically ordered list format together with a graphical overlay on a map representation.

5. The system according to claim 4, wherein the first input data represents a departure location, the second input data represents a destination location, the external information processing apparatus comprises a route information providing apparatus, and the selected data record represents an optimal travel route between the departure location and the destination location.

6. The system according to claim 5, wherein each section data record represents a movement section of the optimal travel route, and the classification label is selected from at least a walking section label, a public transportation section label, and a vehicle section label.

7. The system according to claim 6, wherein the proposal data further comprises means of transportation information, and the circuitry is further configured to:
receive, from the terminal device, a natural language prompt sentence describing preferences for a travel plan; and
construct input data for the generative neural network model by combining the natural language prompt sentence with the proposal data and the selected data record.

8. The system according to claim 1, wherein the circuitry is further configured to:
convert position identifiers included in the result data into coordinate data by referring to a reference information storage; and
transmit, via the communication interface, the coordinate data to a map information providing apparatus to receive detailed path data comprising distance information and time information for each segment.

9. The system according to claim 8, wherein the circuitry is further configured to:
calculate, based on the detailed path data and stay duration data, arrival time data and departure time data for each position identifier; and
generate time schedule data comprising the arrival time data and the departure time data arranged in chronological order.

10. The system according to claim 9, wherein the circuitry is further configured to:
generate route geometry data based on the coordinate data and the detailed path data; and
transmit the route geometry data and the time schedule data to the terminal device to cause the terminal device to render a route display and a time schedule display on a map interface.

11. The system according to claim 10, wherein the circuitry is further configured to:
receive, from the terminal device, updated constraint data specifying at least one of a modified intermediate location, a modified stay duration, or a modified arrival time constraint; and
regenerate the time schedule data based on the updated constraint data without re-executing the computation by the external information processing apparatus for unchanged segments.

12. The system according to claim 1, wherein the circuitry is further configured to:
identify a spatial region surrounding a path represented by the selected data record;
retrieve, from a structured information storage, a plurality of candidate item records located within the spatial region; and
rank the plurality of candidate item records based on an evaluation index and a positional relationship with the selected data record.

13. The system according to claim 12, wherein the circuitry is further configured to:
generate a second prompt sentence for the generative neural network model, the second prompt sentence including identification information and attribute information of the candidate item records; and
analyze output data from the generative neural network model to update the evaluation index of one or more of the candidate item records based on the output data.

14. The system according to claim 13, wherein the candidate item records comprise at least one of sightseeing point information, dining establishment information, or regional specialty information associated with a route-surrounding region of a travel route.

15. The system according to claim 1, wherein the circuitry is further configured to:
apply a state estimation function to input signal data received from the terminal device to generate a state classification label; and
adjust at least one parameter of the prompt sentence based on the state classification label.

16. The system according to claim 15, wherein the state estimation function comprises an emotion identification model, the input signal data comprises at least one of text data, audio data, or image data captured by the terminal device, and the state classification label represents an estimated emotional state of a user.

17. The system according to claim 16, wherein the circuitry is further configured to:
modify a presentation format of the output data transmitted to the terminal device based on the state classification label, the presentation format comprising at least one of a text style parameter, an audio output parameter, or a display layout parameter.

18. The system according to claim 1, wherein:
the circuitry is configured to:
receive, via the communication interface coupled to the packet-switched network, from the terminal device, the first input data and the second input data;
generate the structured instruction data specifying the computation to be performed using the first input data and the second input data as the constraint parameters;
transmit the structured instruction data to the external information processing apparatus and receive the result data;
analyze the result data to select the selected data record;
segment the selected data record into a plurality of section data records;
generate, for each section data record, proposal data comprising a time parameter, a distance parameter, and a classification label;
generate the prompt sentence for instructing the generative neural network model to generate the output data, the prompt sentence including the proposal data and the selected data record as context parameters; and
analyze output data from the generative neural network model to generate structured plan data and transmit the structured plan data to the terminal device.

19. The system according to claim 18, wherein the circuitry is further configured to:
convert location identifiers in the result data into coordinate data by referring to a reference information storage;
generate route geometry data based on the coordinate data; and
transmit the route geometry data together with the structured plan data to the terminal device to cause the terminal device to render a combined route display and plan display.

20. A method performed by circuitry, the method comprising:
receiving, via a communication interface coupled to a packet-switched network, from a terminal device, first input data and second input data each representing a respective location parameter;
generating, based on the first input data and the second input data, structured instruction data for an external information processing apparatus, the structured instruction data specifying a computation to be performed by the external information processing apparatus using the first input data and the second input data as constraint parameters;
transmitting, via the communication interface, the structured instruction data to the external information processing apparatus and receiving, from the external information processing apparatus, result data representing a plurality of candidate data records each associated with the first input data and the second input data;
analyzing the result data to select, from the plurality of candidate data records, a selected data record based on a predetermined selection condition;
generating a prompt sentence for instructing a generative neural network model to generate output data based on the selected data record; and
transmitting, via the communication interface, the output data to the terminal device.
